(19) United States
(12) Patent Application Publication
(10) Pub. No.: US 2021/0336789 A1
(43) Pub. Date: Oct. 28, 2021

(54) DETERMINISTIC SPARSE-TREE BASED CRYPTOGRAPHIC PROOF OF LIABILITIES

(71) Applicant: Facebook, Inc., Menlo Park, CA (US)

(72) Inventors: Konstantinos Chalkias, Menlo Park, CA (US); Kevin Lewi, Mountain View, CA (US); Payman Mohassel, San Jose, CA (US); Valeria Olegovna Nikolaenko, Menlo Park, CA (US)

(21) Appl. No.: 17/206,423

(22) Filed: Mar. 19, 2021

Related U.S. Application Data
(60) Provisional application No. 63/002,298, filed on Mar. 30, 2020.

(51) Int. Cl. H04L 9/32; G06Q 40/08; G06Q 10/10

(52) U.S. Cl. CPC H04L 9/3218; H04L 9/3236; H04L 2209/16; G06Q 10/1053; G06Q 40/08

(57) ABSTRACT

The present disclosure relates to systems, non-transitory computer-readable media, and methods for generating decentralized, privacy-preserving cryptographic proofs of liabilities in connection with immutable databases. In particular, in one or more embodiments, the disclosed systems enable an entity to transparently and accurately report its total amount of liabilities, obligations or other data related to fungible negative reports without exposing any user data or sensitive system data (e.g., the liabilities structure). Furthermore, the disclosed systems can generate a cryptographic proof of liability that allows individual users to independently verify that their committed liability is included in a reported total liability.

### CROSS-REFERENCE TO RELATED APPLICATIONS

This application claims priority to and the benefit of U.S. Provisional Patent Application No. 63/002,298, filed Mar. 30, 2020, which is incorporated herein by reference in its entirety.

### BACKGROUND

Proof of liability is an important scheme that allows companies to prove their total amount of liabilities or obligations. For example, proofs of liabilities can be important for proving various types of liabilities in various industries. For example, proofs of liabilities can be useful in blockchain systems, such as cryptocurrency exchanges. Solvency is the ability of a company to meet its long-term financial commitments. In finance and particularly in blockchain systems, proof of solvency consists of two components: 1. Proof of liabilities: proving the total quantity of coins the exchange owes to all of its customers; and 2. Proof of reserves (also known as proof of assets): proving ownership of digital assets (i.e., coins) in the blockchain. Typically, an exchange should be able to prove on demand that the total balance of owned coins is greater than or equal to their liabilities, which correspond to the sum of coins their users own internally to their platform.

Conventionally, proofs of liabilities are performed by human auditors. The use of human auditors, however, raises various concerns. For example, relying on third-party human auditors to verify claims can lead to inaccuracy and even corruption. An emerging type of proof of liability that seeks to avoid problems associated human auditors is cryptographic proofs of liability/solvency. Unfortunately, conventional cryptographic proof of liability schemes and systems suffer from a number of drawbacks. For example, conventional cryptographic systems often expose sensitive information about the underlying liabilities structure and/or its user-base. In particular, some conventional cryptographic systems leak information such as database size (e.g., number of users) and individual balances or other user information.

Additionally, some conventional cryptographic proof of liability schemes and systems can expose access patterns to the provided proofs. For example, a vulnerable period in the distributed auditing process is when the audited entity uses information of former audits to predict the probability of a user checking their proofs. This information can be utilized by the audited entity to omit particular balances in the upcoming audits, as the risk of being caught is very low.

By leaking and exposing data in these ways, conventional cryptographic proof of liability schemes give rise to system inaccuracies. For example, by exploiting leaking and exposing data, malicious entities can create inaccuracies within a blockchain system in order to syphon-off digital assets. Due to the obfuscated nature of blockchain systems, these inaccuracies are difficult to detect or prove. Moreover, conventional cryptographic proof of liability schemes are generally inaccurate in reporting of liabilities. For example, using conventional cryptographic proof of liability schemes, a reporting entity generally cannot confirm whether a specific liability is included in all reported liabilities (e.g., in a blockchain). A specific example is reporting of confirmed positive cases of an infectious disease. Individuals that test positive typically have no way of confirming that their individual positive test is included in the total number of infections reported by a government or agency.

Furthermore, conventional cryptographic proof of liability schemes often waste computing resources in applying a distributed auditing process. For example, a human auditor often applies various proof of liability techniques in sequence to a data set in an attempt to verify total liabilities and membership. But such sequentially work typically leads to repetitions and redundancies that, in turn, cause the computational cost of verification to increase.

These, along with additional problems and issues, exist with regard to conventional proof of liability schemes and systems.

### SUMMARY

One or more embodiments described herein provide benefits and/or solve one or more of the foregoing or other problems in the art with systems, methods, and non-transitory computer readable storage media for decentralized, privacy-preserving cryptographic proofs of liabilities. For example, one or more embodiments provide for a cryptographic proof of liabilities system that allows an entity to securely, transparently, and accurately report its total amount of liabilities, obligations or other metrics related to fungible negative reports without exposing any user data or sensitive system data (e.g., the liabilities structure). Furthermore, one or more embodiments provide for a cryptographic proof of liabilities system that allows individual users to independently verify that their committed liability is included in a reported total liability.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example distributed network in which a cryptographic proof of liabilities system can operate in accordance with one or more embodiments;

FIG. 2 illustrates a schematic diagram providing an overview of liability splitting and leaf shuffling in in accordance with one or more embodiments;

FIG. 3 illustrates a schematic diagram providing an overview of deterministically determining an audit identifier in accordance with one or more embodiments;

FIG. 4 illustrates a schematic diagram providing an overview of adding fake users with a zero balance liability in accordance with one or more embodiments;

FIG. 5 illustrates a schematic diagram of a sparse tree in accordance with one or more embodiments;

FIG. 6 illustrates a schematic diagram of a sparse tree with a height of two that includes two users and one padding node in accordance with one or more embodiments;

FIG. 7 illustrates a schematic diagram of a signed proof of liabilities in accordance with one or more embodiments;

FIG. 8 illustrates a schematic diagram of a sparse tree showing an authentication path to prove a closest user in accordance with one or more embodiments;

FIG. 9 illustrates a schematic diagram of a cryptographic proof of liabilities system in accordance with one or more embodiments;

FIG. 10 illustrates a flowchart of a series of acts for generating an authentication path establishing that a user's committed liability is reflected in a total liability for a deterministic sparse-tree in accordance with one or more embodiments; and

FIG. 11 illustrates a block diagram of an exemplary computing device in accordance with one or more embodiments.

### DETAILED DESCRIPTION

One or more embodiments include a cryptographic proof of liabilities system that utilizes deterministic sparse-tree based cryptographic proof of liabilities. In particular, in cryptographic proof of liabilities system can utilize a tree construction (e.g., Merkle tree) that is extended using one or more of balance splitting, efficient padding, verifiable random functions, deterministic key derivation functions, or range proof techniques. In at least one embodiment, the cryptographic proof of liabilities system extends a Merkle tree with each of balance splitting, efficient padding, verifiable random functions, deterministic key derivation functions, and range proof techniques. In one or more embodiments, the cryptographic proof of liabilities system deterministically generates a sparse-tree such that every leaf node in the sparse-tree is associated with an authentication path. In one or more embodiments, the cryptographic proof of liabilities system utilizes this list of nodes in the sparse-tree between the leaf node and the root of the sparse-tree to establish that the committed liability associated with the leaf node is reflected in the total liability for the entire sparse-tree.

To illustrate, in one or more embodiments the cryptographic proof of liabilities system generates a deterministic sparse-tree (e.g., a sparse Merkle tree) associated with an immutable database (e.g., a blockchain). For example, the cryptographic proof of liabilities system generates the deterministic sparse-tree by generating and positioning at least one leaf node in the sparse-tree for every user or member in the immutable database. The cryptographic proof of liabilities system can further generate internal nodes for every other level in the sparse-tree that includes sums and concatenations of information from children nodes. By recursively generating the sparse-tree according to these general specifications, the cryptographic proof of liabilities system can ensure that the root node of the sparse-tree reflects a total liability for the entire immutable database, and that an accurate authentication path exists within the sparse-tree between every user leaf node and the root node.

In one or more embodiments, the cryptographic proof of liabilities system utilizes deterministic functions to improve security and protect user liabilities. For example, the cryptographic proof of liabilities system can apply deterministic function to a user liability within a sparse-tree leaf node such that the user's liabilities are obfuscated but cryptographically provable. In one or more embodiments, the cryptographic proof of liabilities system can utilize a deterministic function such as a homomorphic commitment (e.g., a Pedersen commitment) to ensure that any particular liability stay hidden within the sparse-tree and is only usable in comparison with another homomorphic commitment.

To further protect user information, and information about the sparse-tree in general, the cryptographic proof of liabilities system can utilize verifiable random functions (VRFs) and key derivation functions (KDFs) to provide deterministic pre-commitments that can be revealed later using proofs. For example, the cryptographic proof of liabilities system can utilize a key derivation function together with a verifiable random function to generate a unique audit id and blinding factor per user. Based on these unique and deterministically generated values, the cryptographic proof of liabilities system can further ensure that information about users and the sparse-tree remain private, even in between continuous and subsequent audits.

In one or more embodiments, the cryptographic proof of liabilities system further generates the deterministic sparse-tree to obfuscate a total number of users or members within the sparse-tree. For example, the cryptographic proof of liabilities system can generate the sparse-tree including padding nodes with zero balances (e.g., zero liabilities). These padding nodes do not affect the total liability represented in the sparse-tree, but rather serve to hide the number of real user leaf nodes in the tree that carry actual liability balances. In at least one embodiment, the cryptographic proof of liabilities system can position a padding node at the root of every empty sub-tree within the deterministic sparse-tree.

In at least one embodiment, the cryptographic proof of liabilities system can further ensure that the total liability reflected in the root node of the sparse-tree is accurate by generating one or more zero-knowledge range proofs. For example, the cryptographic proof of liabilities system can generate a zero-knowledge range proof for every internal node of the sparse-tree leading up the root node that demonstrates that the committed liability of each node is a small positive number within a predetermined range of numbers. Thus, the cryptographic proof of liabilities system can show at every level of the sparse-tree that the liabilities represented therein are expected.

In one or more embodiments, the cryptographic proof of liabilities system can generate and provide an individual proof of membership or inclusion for any user represented in the deterministic sparse-tree. For example, the cryptographic proof of liabilities system can receive a request from a user client device to verify that a committed liability of the user (e.g., number of coins, positive infection report, vote) is included in the total liability listed at the root node of the sparse-tree. In response to receiving such a request, the cryptographic proof of liabilities system can generate a proof including an authentication path including a list of nodes in the sparse-tree between the user's leaf node and the root node of the sparse-tree. Because of the properties of the sparse-tree, and in some cases also because of a range proof associated with every node in the list, the cryptographic proof of liabilities system can use the authentication path prove to the user that liabilities of the user are correctly reflected in the total liability for the sparse-tree.

In at least one embodiment, the cryptographic proof of liabilities system can deterministically shuffle user leaf nodes of the deterministic sparse-tree every time the sparse-tree is audited. To illustrate, a malicious actor can potentially learn information about the sparse-tree when leaf nodes are relationally ordered in every audit. Accordingly, the cryptographic proof of liabilities system can deterministically shuffle the sparse-tree leaf nodes periodically (e.g., prior to each audit of the sparse-tree) so that no information can be extracted by subsequent ordering.

As mentioned above, the cryptographic proof of liabilities system provides many technical advantages and benefits over conventional proof of liabilities systems. For example, the cryptographic proof of liabilities system improves the accuracy and security with which conventional proof of liabilities systems determine various liabilities. In comparison to conventional systems, the cryptographic proof of liabilities system avoids many of the data leaks and exposures common to other schemes by utilizing a deterministic sparse-tree approach that effectively hides information about the users and accounts represented in the sparse-tree, in addition to hiding information about the sparse-tree itself (e.g., the tree size). In this way, the cryptographic proof of liabilities system avoids the data inaccuracies of conventional systems that are often exploited by malicious entities.

Additionally, the cryptographic proof of liabilities system improves the accuracy of conventional systems by utilizing the structure of the deterministic sparse-tree to determine accurate liability proofs. For example, the cryptographic proof of liabilities system utilizes key derivations and verifiable random functions in connection with nodes at every level of the sparse-tree to ensure that a parent node accurately reflect liability information of both children nodes. Thus, the cryptographic proof of liabilities system can ensure that a total liability reflected in the root node of the sparse-tree accurately reflects each contributing leaf node liability.

Furthermore, the cryptographic proof of liabilities system also improves the efficiency of conventional systems. For example, the cryptographic proof of liabilities system presents, to an auditor or user, an elegant and robust proof of liability based on a single generated deterministic sparse-tree. As such, the cryptographic proof of liabilities system minimizes the computational verification costs typically associated with proving the liabilities of an immutable database, such as a blockchain.

In addition to these technical advantages and benefits, the cryptographic proof of liabilities system also provides various privacy and security advances over conventional systems. For example, the cryptographic proof of liabilities system improves the following privacy and security shortcomings common to conventional systems.

Account Information Leaks—Conventional systems generally leak account information. For example, in a proof structured as a Merkle Tree, a verifying user can learn the balance belonging to a sibling leaf node in the Merkle Tree. Even when the leaf nodes are shuffled, a verifier can learn something about the distribution of balances. As will be described in greater detail, in one or more implementations the cryptographic proof of liabilities system ensures that no data about individual users (id or balance) is ever revealed, even between independent audits.

Exchange Information Leaks—In publishing total liability amounts associated with exchanges, conventional systems generally expose information about the exchanges that can be exploited. For example, a malicious entity can extract business information on the success of an exchange's business. As will be described in greater detail, in one or more implementations the cryptographic proof of liabilities system proves the option to reveal or not reveal total liabilities.

Dependence on Complete Account-Holder Verification—Conventional systems may not require universal participation to verify correctness of a liability proof. In contrast, in one or more implementations the cryptographic proof of liabilities system distributes the responsibility for verifying both the integrity and the correctness of a proof of liability to all account holders. As will be discussed further below, this distribution further ensures greater accuracy of the proof of liability because each participating user verifies the correctness of his or her authentication path.

Interactive access to the proof—In one or more implementations, the cryptographic proof of liabilities system ensures each account holder receives an individual inclusion proof from the exchange containing only the nodes between their own leaf node and the root, while protecting against leaking information about the user inclusion proof requests. For example, utilizing conventional systems, a malicious prover can use the identities of inclusion proof requesting users to omit users who rarely or never check their inclusion proofs. As will be discussed further below, the cryptographic proof of liabilities system can guard against this type of leak using padding nodes.

Independent Verification Tool—Conventional systems generally fail to provide users with an automated independent verification tool. In one or more implementations, the cryptographic proof of liabilities system provides each account holder with an individual proof containing only the nodes between their own leaf node and the root.

Number of users—As mentioned above, conventional systems often leak information about an exchange or other body that includes the number of users. This information can be exploited by malicious entities in various ways. As will be discussed in greater detail below, the cryptographic proof of liabilities system can generate proofs of liability that hide the total number of users such that that number is not leaked or discoverable.

Implementation issues—As mentioned above, conventional system often leak user information to an auditor. As with the number of users above, this leaked information can be exploited by malicious entitles in various ways. The cryptographic proof of liabilities system, in contrast, can generate proofs of liability that do not expose user information to the auditor (including individual balances), unless it is required for dispute resolution and routine sampling.

Subsequent audits Conventional systems often leak information between subsequent audits. For example, a traditional proof of liability mainly consists of a commitment to each user's balance and a proof that said balance is within a range. For all new users and users whose balance has changed, the commitment the proof is regenerated in a subsequent audit. For the other users, the proof of liability need not be regenerated. However, not changing the proofs for users whose balance remained unchanged will leak how many users were actively using their account between the two proofs. Thus, in one or more implementations, the cryptographic proof of liabilities system regenerates a complete proof of liability for all users in each audit such that this user information remains private.

As illustrated by the foregoing discussion, the present disclosure utilizes a variety of terms to describe features and advantages of the cryptographic proof of liabilities system. Additional detail is now provided regarding the meaning of such terms. For example, as used herein, “deterministic sparse-tree” refers to a binary tree data structure. In one or more embodiments, as described herein, a deterministic sparse-tree includes a sparse Merkle tree that includes one or more leaf nodes, padding nodes, and a single root node.

As used herein a “leaf node” refers to a node at a lowest level of a sparse-tree. As will be described in greater detail below, a deterministic sparse-tree includes user information only in its leaf nodes. As used herein a “root node” refers to the top-most node of a sparse-tree. As will be described in greater detail below, a deterministic sparse-tree includes only one root node, and the root node of the deterministic sparse-tree includes a committed liability that reflects a total liability for all nodes in the deterministic sparse-tree. As used herein, “internal nodes” refer to nodes in the sparse-tree that are between the leaf nodes and the root node. As used herein, “padded node” refers to a node that does not reflect a user or account. For example, a padded node can include a node representing a simulated user with a committed balance of zero. As will be described in greater detail below, the cryptographic proof of liabilities system can utilize padded nodes in the sparse-tree to obscure a total number of authentic users included in the sparse-tree.

As used herein, “committed liability” refers to an amount associated with a user (e.g., a number of coins, a monetary balance, a negative vote). For instance, a committed liability can include an amount that is deterministically obscured by a homomorphic commitment such as a Pedersen commitment. In one or more embodiments, such a homomorphic commitment is binding while revealing nothing about the committed value (e.g., the user's liability).

As used herein, “total liability” refers to a sum of liabilities (e.g., total liabilities represented by a deterministic sparse-tree such as a total number of coins in a blockchain exchange, total number of negative votes, etc.). For example, the cryptographic proof of liabilities system recursively generates the sparse-tree such that the balance of the root node reflects the total liability for all nodes in the sparse-tree.

As used herein, an “authentication path” refers to a list of nodes in a deterministic sparse-tree from a particular leaf node to the root node. In one or more embodiments, an authentication path from a user's leaf node to the root node of a deterministic sparse-tree assists in proving that the user's individual liability is reflected in the total liability for the entire sparse-tree.

As used herein, a “deterministic function” refers to a function that returns the same result when applied to the same inputs. In other words, a deterministic function is not random or stochastic. As used herein, a “verifiable random function” refers to a pseudo-random function that provides publicly verifiable proofs of its outputs' correctness. As used herein, a “key derivation function” refers to a cryptographic hash function that derives one or more secret keys from a secret value such as a master key or password using a pseudo-random function.

As used herein, a “zero-knowledge range proof” refers to a cryptographic method that allows a prover to prove to a verifier that a given value lies within a certain range. For example, as used herein, a zero-knowledge range proof proves that a balance of a node is a small positive number within a given range.

As used herein, an “immutable database” refers to a data collection including entries that cannot be modified once they are added. As mentioned above, a blockchain is a popular example of an immutable database.

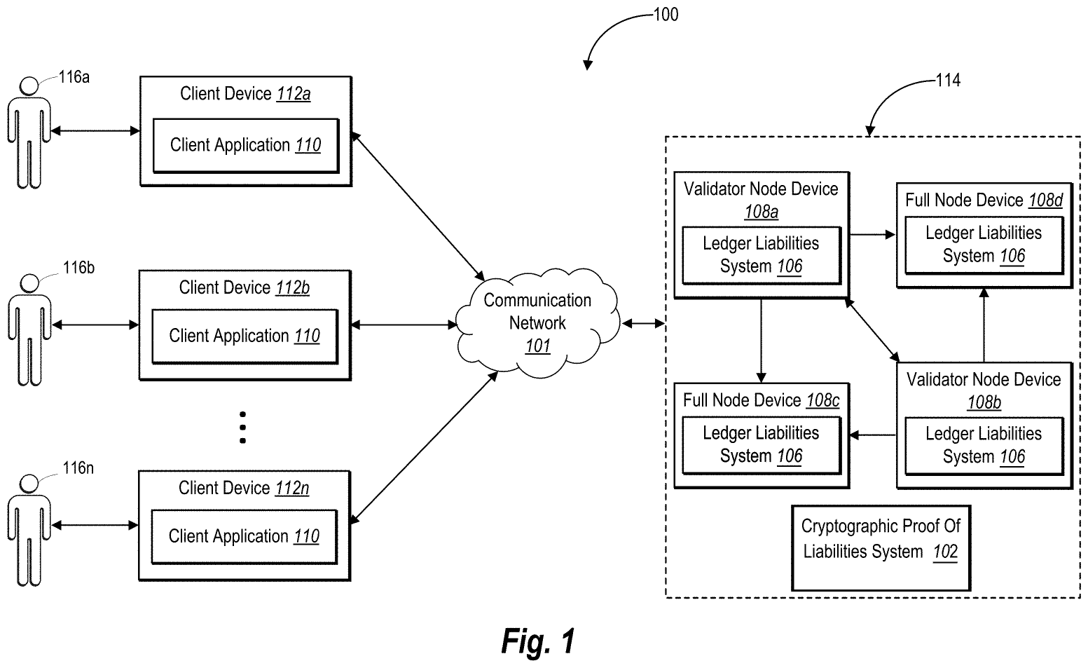

Additional detail regarding the cryptographic proof of liabilities system will now be provided with reference to the figures. For example, FIG. 1 illustrates a schematic diagram of a distributed digital ledger transaction network 100 in which a ledger liabilities system 106 can be implemented. As illustrated in FIG. 1, the distributed digital ledger transaction network 100 includes a communication network 101, computer nodes 114 (which include validator node devices 108a-108b and full node devices 108c-108d), and client devices 112a-112n (having corresponding users 116a-116n).

Although the distributed digital ledger transaction network 100 of FIG. 1 is depicted as having a particular number of components, the distributed digital ledger transaction network 100 can have any number of additional or alternative components (e.g., any number of computer nodes, client devices, or other components in communication with the ledger liabilities system 106 via the communication network 101). Similarly, although FIG. 1 illustrates a particular arrangement of the communication network 101, the computer nodes 114, the client devices 112a-112n, and the users 116a-116n, various additional arrangements are possible.

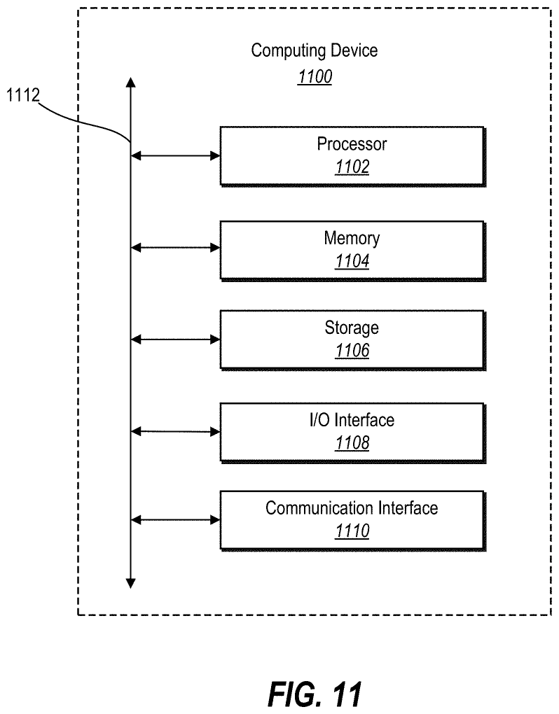

The communication network 101, the computer nodes 114, and the client devices 112a-112n may be communicatively coupled with each other either directly or indirectly (e.g., through the communication network 101 discussed in greater detail below in relation to FIG. 11). Moreover, the computer nodes 114, and the client devices 112a-112n may include a computing device (including one or more computing devices as discussed in greater detail below with relation to FIG. 11).

As mentioned above, the distributed digital ledger transaction network 100 includes the computer nodes 114. In general, the computer nodes 114 can generate, store, receive, and/or transmit data, including data corresponding to a digital ledger. For example, the computer nodes 114 can receive transaction requests and transmit transaction execution results. In one or more embodiments, at least one of the computer nodes 114 comprises a data server. In some embodiments, at least one of the computer nodes 114 comprises a communication server or a web-hosting server. In further embodiments, one or more of the computer nodes 114 include personal computing devices operated by a user.

In one or more embodiments, as shown in FIG. 1, the computer nodes can transmit data to one another. For example, a given computer node can transmit data to a particular computer node (i.e., one computer node) using point-to-point communication. A given computer node can also transmit data to all other computer nodes using broadcasting techniques. For example, in one or more embodiments, a computer node broadcasts data by transmitting the data to a random or semi-random subset of computer nodes with voting power (e.g., validator node devices). The recipient validator node devices can then reshare (i.e., retransmit) to other computer nodes in the same way until the data known to (i.e., stored at) every computer node stabilizes.

In one or more embodiments, a computer node transmits data to other computer nodes in several steps. For example, at a first step, the transmitting computer node can make the data available (i.e., passively publish the data). The transmitting computer node can then send a notification to each potential recipient computer node, indicating that the data is now available. Subsequently, the transmitting computer node can let the potential recipient computer nodes connect to the transmitting computer node and retrieve the available data.

As shown FIG. 1, the computer nodes include the validator node devices 108a-108b and the full node devices 108c-108d. As will be discussed in greater detail below, the validator node devices 108a-108b and the full node devices 108c-108d can perform different functions; though, in some embodiments, the validator node devices 108a-108b and the full node devices 108c-108d perform, at least some, overlapping functions. For example, in one or more embodiments, both the validator node devices 108a-108b and the full node devices 108c-108d can service queries for information regarding transactions, events, or states of user accounts.

Additionally, as shown in FIG. 1 the computer nodes 114 include the ledger liabilities system 106. In particular, in one or more embodiments, the ledger liabilities system 106 utilizes the computer nodes 114 to execute transactions and service queries for information. For example, the ledger liabilities system 106 can use the validator node devices 108a-108b to execute transactions and implement a consensus protocol. Further, the ledger liabilities system 106 can utilize the full node devices 108c-108d to receive and service queries for information.

For example, in one or more embodiments, the ledger liabilities system 106 implements a Byzantine-fault-tolerant consensus approach. Specifically, in some embodiments, the validator node devices 108a-108b implement a modified HotStuff consensus protocol. In particular, in one or more embodiments, the computer nodes 114 select a lead validator node device to drive consensus for a transaction block. In one or more embodiments, the lead validator node device is selected deterministically (e.g., via a round-robin selection from a pre-defined list). In some embodiments, the lead validator node device is selected non-deterministically (e.g., candidate validator node devices attempt to solve a cryptographic puzzle or participate in a cryptographic lottery, and the winner becomes the lead validator node device). When selected, a lead validator node device can assemble a transaction block containing transactions received from one or more of the client devices 112a-112n and propose the transaction block to the other validator node devices. The other validator node devices execute the transactions within the transaction block and then vote on the execution results.

For example, assume that there exists a fixed, unknown subset of malicious validator node devices (also known as “Byzantine validator node devices) within the current set of validator node devices. Assume further that all other validator node devices (known as “honest validator node devices”) follow the consensus protocol scrupulously. Referring to the total voting power of all validator node devices as N and defining a security threshold f, the ledger liabilities system 106 can operate so that N>3f In other words, the ledger liabilities system 106 can operate so that the combined voting power of the malicious node devices does not exceed the security threshold f.

A subset of nodes whose combined voting power M verifies a transaction block (i.e., M≥N−j) can be referred to as a quorum. In some embodiments, the ledger liabilities system 106 can further operate under a “BFT assumption” that indicates, for every two quorums of nodes in the same epoch, there exists an honest node that belongs to both quorums.

Upon determining that a threshold number of votes confirming the execution results have been received, the lead validator node device can determine to finalize the block of transactions and transmit confirmation to the other validator node devices. As mentioned above, by utilizing a Byzantine failure model, the ledger liabilities system 106 can accommodate validators that arbitrarily deviate from the protocol without constraint. Moreover, the ledger liabilities system 106 can utilize a byzantine fault tolerance consensus approach to mitigate failures caused by malicious or hacked validators. Specifically, in one or more embodiments, the ledger liabilities system 106 utilizes 2f+1 votes as the threshold number of votes, where f refers to a number of Byzantine voters (e.g., malicious, fraudulent, or untrustworthy validators) that can be accommodated by the consensus protocol. For instance, in some embodiments f reflects the number of Byzantine voters that can be accommodated while preventing attacks or other unsafe behaviors (e.g., double-spends or forks). In some embodiments, 2f+1 votes corresponds to just over two-thirds of the validator node devices participating in consensus.

Once the block of transaction is finalized, the validator node devices can commit the transaction results to storage. Indeed, in one or more embodiments, each validator node device generates data structures for storing data relevant to the digital ledger (e.g., a transaction data structure, a state data structure, and an event data structure). The validator node devices can update these data structures based on the execution results when the execution results achieve consensus. In particular, each validator node device can generate and maintain an independent copy of the data structures and then update the data structures stored at that validator node device based on the execution results.

To provide an additional example, in one or more embodiments, a full node device can receive a query for information. In response, the full node device can locate the relevant data within the data structures stored at the full node device and transmit the data to the requesting client device. Indeed, in one or more embodiments, each full node device can generate and maintain an independent copy of the data structures. The full node device can communicate with the validator node devices 108a-108b to identify the results of executing transactions and update the data structures stored at the full node device accordingly. In one or more embodiments, the full node device can further submit a proof (e.g., a Merkle proof) to demonstrate the accuracy of the provided data in response to receiving the query for information. In particular, the full node device can implement the cryptographic proof of liabilities system 102 described below to provide deterministic sparse-tree based cryptographic proof of liabilities.

In one or more embodiments, the client devices 112a-112n include computer devices that allow users of the devices (e.g., the users 116a-116n) to submit transaction requests and queries for information. For example, the client devices 112a-112n can include smartphones, tablets, desktop computers, laptop computers, or other electronic devices (examples of which are described below in relation to FIG. 11). The client devices 112a-112n can include one or more applications (e.g., the client application 110) that allow the users 116a-116n to submit transaction requests and queries for information. For example, the client application 110 can include a software application installed on the client devices 112a-112n. Additionally, or alternatively, the client application 110 can include a software application hosted on one or more servers, which may be accessed by the client devices 112a-112n through another application, such as a web browser.

In some embodiments, a subset of the client devices 112a-112n (and/or a subset of the computer nodes 104) can have cryptographic keys to modify or manage features of the distributed digital ledger transaction network (referred to as “authorized devices”). In particular, smart contracts can be implemented that provide authorized devices (or authorized accounts corresponding to authorized devices) with permissions to make modifications through consensus protocols (and collective agreement among the authorized devices). For example, within the confines of smart contracts used to make modifications, authorized devices can manage changes to the set of validator node devices participating in consensus (i.e., voting rights), changes to the processes utilized in validating rejections or distributing transaction fees (i.e., gas) amongst the computer nodes 114, and/or changes to tangible monetary reserves (e.g., diverse real-world assets) utilized to back digital assets (e.g., a cryptographic currency) on the distributed digital ledger transaction network.

In one or more embodiments, the distributed digital ledger transaction network 100 further includes one or more reporting managers (not shown). The reporting manager can track and report actions taken by the components of the distributed digital ledger transaction network 100 (e.g., one of the validator node devices 108a-108b) for which rewards should be provided or fees extracted. Some actions that the reporting manager can track and report include, but are not limited to, a client device submitting a transaction request, a lead validator node device proposing or failing to propose a transaction block, a lead validator node device proposing an incorrect or malformed transaction block, validator node devices participating in consensus, validator node devices committing a block of transactions to storage, and general information dissemination (whether among the computer nodes 114 or to the client devices 112a-112n). In one or more embodiments, the reporting manager reports such actions to the computer nodes 114 to determine and carryout the corresponding reward or fee. The reporting manager can be implemented by any of the devices of the distributed digital ledger transaction network 100 shown in FIG. 1 (e.g., implemented by a computer nodes 114) or another computing device.

The ledger liabilities system 106 can be implemented in whole, or in part, by the individual elements of the distributed digital ledger transaction network 100. Indeed, although FIG. 1 illustrates the ledger liabilities system 106 implemented with regards to the computer nodes 114, different components of the ledger liabilities system 106 can be implemented in any of the components of the distributed digital ledger transaction network 100. In particular, part of, or all of, the ledger liabilities system 106 can be implemented by a client device (e.g., one of the client devices 112a-112n).

To provide an example, the ledger liabilities system 106 can utilize the client devices 112a-112n to perform various functions. To illustrate, the ledger liabilities system 106 can utilize a client device to poll one or more of the computer nodes 114 for transaction event updates and request data corresponding to a sequence of events. Additionally, the ledger liabilities system 106 can utilize a client device to generate a transaction request. In particular, the ledger liabilities system 106 can utilize a client device to identify a main public address identifier and sub-address identifier corresponding to a user account and then encrypt the sub-address identifier using an encryption key. The ledger liabilities system 106 can then utilize the client device to generate and submit a transaction request associated with the user account using the main public address identifier and the encrypted sub-address corresponding to that user account.

In one or more embodiments, the ledger liabilities system 106 comprises the ledger transaction system 106 as described in U.S. patent application Ser. No. 16/442,476 filed on Jun. 15, 2019 and hereby incorporated by reference in its entirety.

As mentioned above, the cryptographic proof of liabilities system 102 can utilize one or more cryptographic primitives, algorithms, or techniques to provide the above-identified advantages. An overview of such cryptographic primitives, algorithms, or techniques is now provided. For example, the cryptographic proof of liabilities system 102 can utilize Merkle trees in one or more embodiments.

Merkle trees are hierarchical data structures that enable secure verification of collections of data. In a Merkle tree, each node has been given an index pair (i;j) and is represented as N(i;j). The indexes i, j are numerical labels that are related to a specific position in the tree. The construction of each of node of a Merkle tree can be governed by the following (simplified) equations:

$$N ( i , j ) = \{ \begin{matrix}H ( {D}_{i} ) & i = j \\ H ( N ( i , k ) \vert \vert N ( k + 1 , j ) & i \neq j\end{matrix}$$

where k=(i+j−1)=2 and H is a cryptographic hash function.

The i=j case corresponds to a leaf node, which is the hash of the corresponding i-th packet of data Dᵢ. The i≠j case corresponds to an internal or parent node, which is generated by recursively hashing and concatenating child nodes, until one parent (the Merkle root node) is found. The tree depth M is defined as the lowest level of nodes in the tree, and the depth m of a node is the level at which the node exists.

The cryptographic proof of liabilities system 102 can utilize a Merkle tree to verify that some data packet Dᵢ is a member of a list or set (known as set-membership) of N data packets δ D₁, . . . , D_{N}. The mechanism for verification is known as a Merkle proof, and includes obtaining a set of hashes known as the authentication path for a given data packet Dᵢ and Merkle root R. The authentication path for a data packet is the minimum list of hashes required to reconstruct the root R by way of repeated hashing and concatenation.

More particularly, in one or more embodiments, the cryptographic proof of liabilities system 102 can utilize a summation Merkle tree, which is a modified Merkle tree. For example, a summation Merkle tree is characterized as having every leaf consist of (v, h) where v is a numeric value (i.e., balance) and h is a blob (e.g., usually the result of a hash result under a collision-resistant hash function H). The main difference between a regular and a summation Merkle tree, is that in summation trees, each internal node contains a numeric value which equals the sum of its children amounts. Thus, all of the leaf balances are filled up in a bottom-up order, such that the final balance of the root node is the summation of all leaf node numeric values. As such, a summation Merkle tree can comprise a secure proof of sum correctness scheme, if the total sum at the root node equals the sum of the amounts of all leaves in the tree and the cumulative relation between the internal node and its children holds. Every intersection node of two successfully verified paths remains the same as the one on the established summation Merkle tree, assuming the collision resistance of the hash functions. For a decentralized auditing proof of liabilities scheme where clients independently verify that their balances are included in the total amount reported, the scheme is secure if the claimed liabilities are no less than the sum of the amount in the dataset when no verification fails. In at least one embodiment and based on a secure modification of the Maxwell protocol, the cryptographic proof of liabilities system 102 includes both child balances unsummed rather than just their sum (i.e., h=H(v₁∥v₂∥h₁∥h₂)) in order for the corresponding parent internal node to achieve summation correctness. This approach is secure, while h=H(v₁+v₂∥h₁∥h₂) is not.

To protect user balances, the cryptographic proof of liabilities system 102 can utilize a commitment scheme. For example, in one or more embodiments, the cryptographic proof of liabilities system 102 can utilize Pedersen commitments. In such embodiments, the cryptographic proof of liabilities system 102 lets G be a cyclic group with s=|G| elements, and lets g and h be two random generators of G. Then the cryptographic proof of liabilities system 102 sets a commitment to an integer v 0, 1, . . . , s−1 as follows: pick commitment randomness r, and return the commitment c:=COM(v, r)=g^{v}h^{r}.

The cryptographic proof of liabilities system 102 can utilize a commitment because the commitment c reveals nothing about the committed value v. In a similar way, the commitments are also computationally binding: if an adversary can open a commitment c in two different ways (for the same r, two different values v and v^{l}), then the same adversary can be used to compute logₕ(g) and thus break the discrete logarithm problem in G.

In one or more embodiments, the cryptographic proof of liabilities system 102 can utilize commitments that are additively homomorphic. If c₁ and c₂ are two commitments to values v₁ and v₂, using commitment randomness r₁ and r₂, respectively, then c:=c₁×c₂ is a commitment to v₁+v₂ using randomness r₁+r₂, as c=(g^{v1} h^{r1})×(g^{v2}h^{r2})=_{g}v1+v2ₕr1+r2.

In one or more implementations, the cryptographic proof of liabilities system 102 can utilize a commitment scheme to protect some user balances, while also exposing other user balances. For example, in the case of an exchange, the cryptographic proof of liabilities system 102 expose balances less than a threshold amount, e.g., one dollar or two dollars. The cryptographic proof of liabilities system 102 can do so to reduce processing times and computing resources to encrypt these balances. In other words, in some embodiments the computing savings can outweigh the privacy concerns for small balances.

The cryptographic proof of liabilities system 102 can utilize a set membership proof to allow a prover to prove, in a zero-knowledge way, that their secret lies in a given public set. The cryptographic proof of liabilities system 102 can utilize such a proof, for instance, in the context of electronic voting, where the voter needs to prove that his secret vote belongs to the set of all possible candidates. In the liabilities case, the cryptographic proof of liabilities system 102 can utilize such a proof to prove inclusion of a user's balance to the reported total value. Another popular special case of the set membership problem occurs when the set S consists of a range [a, a+1, a+2, . . . , b]—which we denote [a, b].

The cryptographic proof of liabilities system 102 can let C=(Gen, Com, Open) be the generation, the commit and the open algorithm of a string commitment scheme. For an instance c, a proof of set membership with respect to commitment scheme C and set S is a proof of knowledge for the following statement: PK(σ, p): c←Com(σ; p)∧σ∈S.

The cryptographic proof of liabilities system 102 can be defined with respect to any commitment scheme. Thus, in particular, if Com is a perfectly-hiding scheme, then the language Γ_{S} includes of all commitments (assuming that S is non-empty). Thus for soundness, the protocol can be a proof of knowledge.

The cryptographic proof of liabilities system 102 can also utilize Zero-Knowledge Range Proofs (ZKRP) to allow for proofing that a number lies within a certain range. In short, given a commitment to a value v, prove with zero-knowledge that v belongs to some discrete set S. For the purposes of this work, S is a numerical range such as [0, 2⁶⁴−1]. Thus, a range proof with respect to a commitment scheme C is a special case of a proof of set membership in which the set S is a continuous sequence of integers S=[a, b] for a, b∈N.

The cryptographic proof of liabilities system 102 can also utilize a Verifiable Random Function (VRF), which is pseudorandom function that gives a public verifiable proof of its output based on public input and private key. In short, the cryptographic proof of liabilities system 102 can utilize a VRF to map inputs to verifiable pseudorandom outputs. In particular, the cryptographic proof of liabilities system 102 can utilize a VRF to provide deterministic pre-commitments that can be revealed later using proofs. More particularly, the cryptographic proof of liabilities system 102 can utilize VRFs for deterministic and unique generation of audit ids and inherently Merkle trees.

The cryptographic proof of liabilities system 102 can utilize a VRF that is a triple of the following algorithms:

KeyGen(r)→(VK, SK). The cryptographic proof of liabilities system 102 can utilize a Key generation algorithm to generate a verification key VK and a secret key SK on random input r.

Eval(SK, M)→(O,π). The cryptographic proof of liabilities system 102 can utilize an Evaluation algorithm to take the secret key SK and message M as input and produce pseudorandom output string O and proof π.

Verify(VK, M, O, π)→0/1. The cryptographic proof of liabilities system 102 can utilize a verification algorithm that takes input as verification key VK, message M, output string O, and proof π. The verification algorithm can output 1 if and only if it verifies that O is the output produced by the evaluation algorithm on input secret key SK and message M, otherwise the verification algorithm outputs 0.

The cryptographic proof of liabilities system 102 can utilize a VRF to support uniqueness according to which, for any fixed public VRF key and for any input alpha, there is a unique VRF output beta that can be proved to be valid. The cryptographic proof of liabilities system 102 can utilize a VRF where Uniqueness holds even for an adversarial Prover that knows the VRF secret key SK.

The cryptographic proof of liabilities system 102 can utilize a VRF that is collision resistant. In other words, the cryptographic proof of liabilities system 102 can utilize a VRF where Collison resistance holds even for an adversarial Prover that knows the VRF secret key SK.

The cryptographic proof of liabilities system 102 can utilize a VRF that is a pseudorandom function. Pseudorandom-ness ensures that the VRF hash output beta (without its corresponding VRF proof pi) on any adversarially-chosen “target” VRF input alpha looks indistinguishable from random for any computationally bounded adversary who does not know the private VRF key SK.

Publicly accessible databases are an indispensable resource for retrieving up-to-date information. But publicly accessible databases also pose a significant risk to the privacy of the user, since a curious database operator can follow the user's queries and infer what the user is after. Indeed, in cases where the user's intentions are to be kept secret, users are often cautious about accessing the database.

In recurring audits, an important property that a complete distributed liabilities proof solution should satisfy, is to serve the inclusion proofs to clients without learning which proof has been requested. This is desirable, because the audited entity can extract information about users who never or rarely check their proofs and thus the risk from omitting their balances from upcoming audit proofs is statistically lower.

Private Information Retrieval (PIR) is a protocol that allows a client to retrieve an element of a database without the owner of that database being able to determine which element was selected. While this problem admits a trivial solution—sending the entire database to the client allows the client to query with perfect privacy—there are techniques to reduce the communication complexity of this problem, which can be critical for large databases.

Additionally, Strong Private Information Retrieval (SPIR) is private information retrieval with the additional requirement that the client only learn about the elements for which he or she is querying, and nothing else. This requirement captures the typical privacy needs of a database owner.

As noted above, cryptographic proof of liabilities system 102 can utilize deterministic sparse-tree based cryptographic proof of liabilities. In one or more embodiments, the cryptographic proof of liabilities system 102 utilizes a Merkle tree. In one or more embodiments, each leaf node contains a user's liability, as well as the hash of the balance concatenated with the customer id and a fresh nonce (i.e., a hash-based commitment). To ensure that one cannot claim less liabilities than the sum of the amount of all users' contributions, the cryptographic proof of liabilities system 102 can add to the hash balances separately instead of aggregating them first. An internal node stores the aggregate balance of its left child and right child, as well as the hash of its left and right children data. The root node stores the aggregate of all customers' liabilities. When a user desires to verify if their liability is included in the total liabilities, it is sufficient to only receive part of the hash tree in order to perform the verification. Specifically, the cryptographic proof of liabilities system 102 can send to the user their nonce and the sibling node of each node on the unique path from the user's leaf node to the root node, this is called the authentication path.

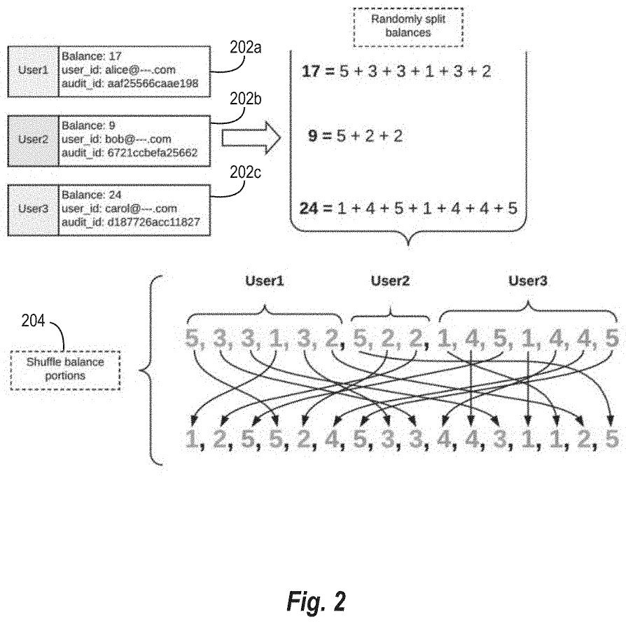

To add privacy in one or more embodiments, the cryptographic proof of liabilities system 102 splits liabilities into multiple leaves (e.g., a user's liabilities can be split into multiple leaves than be associated with a single leaf). In such implementations, the cryptographic proof of liabilities system 102 can shuffle all the leaves before adding them to the tree. For example, FIG. 2 illustrates one embodiment of how the cryptographic proof of liabilities system 102 can split balances/liabilities and shuffle the leaves. As shown in FIG. 2, the cryptographic proof of liabilities system 102 can randomly split the balance associated with the leaf node 202a six ways. Similarly, the cryptographic proof of liabilities system 102 can randomly split the balances associated with the leaf nodes 202b, 202c three ways and seven ways, respectively. In at least one embodiment, the cryptographic proof of liabilities system 102 can generate a leaf node for each split balance such that each generated leaf node includes the information from the original leaf node 202a-202c (e.g., user_id, audit_id) in addition to the split balance amount. As a result of this random splitting, the cryptographic proof of liabilities system 102 replaces the original three leaf nodes 202a-202b with sixteen split-balance leaf nodes.

Following this splitting, the cryptographic proof of liabilities system 102 can shuffle the split-balance leaf nodes (204). For example, as shown in FIG. 2, the cryptographic proof of liabilities system 102 can shuffle the split-balance leaf nodes such that a malicious entity would be unable to determine 1) the total liability represented across all nodes (e.g., 50), 2) a total number of users (e.g., 3), and 3) each user's individual balance.

Due to splitting, each user will receive multiple authentication paths and although the tree height might grow, less information is exposed by sibling leaves, while the size of user-base is obfuscated. By splitting the leaves, the cryptographic proof of liabilities system 102 can limit exposure of user liabilities to both an auditor and other users, fully protect identifies as there is no link between splits of the same liabilities, conceal the total number of users, prevent subsequent proofs of solvency from learning any of the foregoing by utilizing independent audits and different split/shuffling, and prevent correlation of balances between different audits and prevent extraction of statistical data around specific user's profit/loss by utilizing randomized splitting and shuffling.

In addition to the foregoing, the cryptographic proof of liabilities system 102 can replace visible balances with homomorphic commitments. In one or more embodiments, the cryptographic proof of liabilities system 102 can utilize a zero-knowledge proof (ZKP) to prevent an entity from inserting fake accounts with negative balances. For example, the cryptographic proof of liabilities system 102 can utilize a zero-knowledge range proof (ZKRP) with an aggregation technique, such as that in Bulletproofs, so that any proof is dominated by one commitment per user, thereby ensure that the proof is compact. By replacing visible balances with homomorphic commitments, the cryptographic proof of liabilities system 102 can keep the total value of the liabilities secret (from the auditor, public or users), and prevent exposure of individual balances (i.e., from sibling nodes).

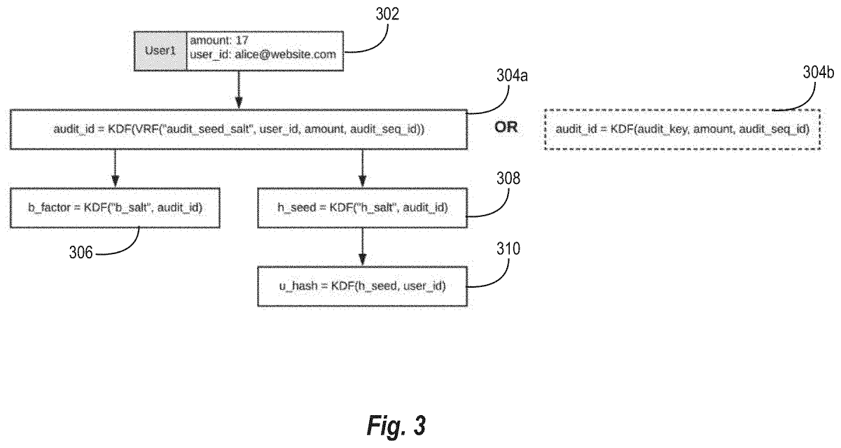

To provide further security guarantees, the cryptographic proof of liabilities system 102 can utilize a zero-knowledge range proof combined with a deterministic sparse Merkle tree construction. In particular, as shown in FIG. 3, the cryptographic proof of liabilities system 102 can utilize Key Derivation Functions (KDF) on top of VRFs to compute each audit id and blinding factor deterministically.

In non-deterministic constructions, a malicious entity can put all of the users that based on some analysis have higher probability of checking their proofs next to each other, and thus statistically, only a small part of the tree might be verified for correctness. The cryptographic proof of liabilities system 102 allows for better dispersion of users' leaves by allowing deterministic shuffles on each audit. In particular, the cryptographic proof of liabilities system 102 can sort the hash values of the leaves before putting them on the tree. Because the cryptographic proof of liabilities system 102 computes hashes deterministically, due to the properties of VRF, a malicious entity cannot arbitrarily fix the relational ordering of user nodes in the tree. The cryptographic proof of liabilities system 102 can also ensure that this deterministic ordering is always different between different audit rounds, thus no information can be extracted by subsequent ordering.

When using a deterministic sparse-tree for cryptographic proof of liabilities, the complete proof can be a full binary summation tree of height H, where the leaf data is generated from user's account data by applying a deterministic function for the creation of a unique audit id and blinding factor per user. A user's audit id is sometimes called a nonce. FIG. 3 shows the full process for the generation of b_factor (blinding factor) and h (user's leaf hash).

For example, as shown in FIG. 3, the cryptographic proof of liabilities system 102 can generate the audit_id 304a (or alternatively the audit_id 304b) based on information from the user's leaf node 302. For instance, the cryptographic proof of liabilities system 102 can generate the audit_id 304a based on first applying a verifiable random function to the user_id and amount, both taken from the user leaf nod 302, in association with an audit_seq_id (e.g., a sequence identifier for the current audit) and an “audit_seed_salt” (e.g., a seed amount for the randomizer). The cryptographic proof of liabilities system 102 can next apply a key derivation function to the output of that verifiable random function to determine the audit_id 304a. Alternatively, the cryptographic proof of liabilities system 102 can determine the audit_id 304b by applying a key derivation function to the amount (e.g., taken from the user leaf node 302) in connection with the audit_seq_id and an audit_key (e.g., a secret value specific to the current audit).

The cryptographic proof of liabilities system 102 can also determine other values based on the audit_id 304a. For example, as shown in FIG. 3, the cryptographic proof of liabilities system 102 can determine b_factor 306 (e.g., the blinding factor) by applying a key derivation function to the audit_id 304a in connection with “b_salt” (e.g., another randomizer value). Similarly, the cryptographic proof of liabilities system 102 can determine h_seed 308 (e.g., a seed value for the user hash function) by applying a key derivation function to the audit_id 304a in connection with “h_salt” (e.g., another randomizer value). Additionally, the cryptographic proof of liabilities system 102 can determine u_hash 310 (e.g., the user hash) by applying a key derivation function to the user_id (e.g., from the user leaf node 302) in connection with h_seed 308.

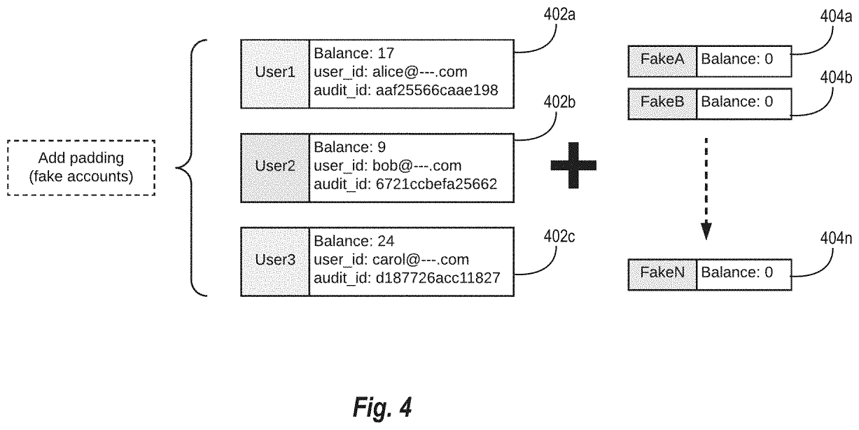

As noted, the cryptographic proof of liabilities system 102 can utilize a sparse Merkle tree. In other words, as shown by FIG. 4, the cryptographic proof of liabilities system 102 can add padding nodes 404a and 404b to 404n (e.g., fake accounts with zero balances) to the sparse-tree including real user leaf nodes 402a, 402b, 402c. By padding the tree, the cryptographic proof of liabilities system 102 can obfuscate the population size of the user-base. Additionally, the cryptographic proof of liabilities system 102 can minimize the number of fake users (with zero balances) for padding purposes.

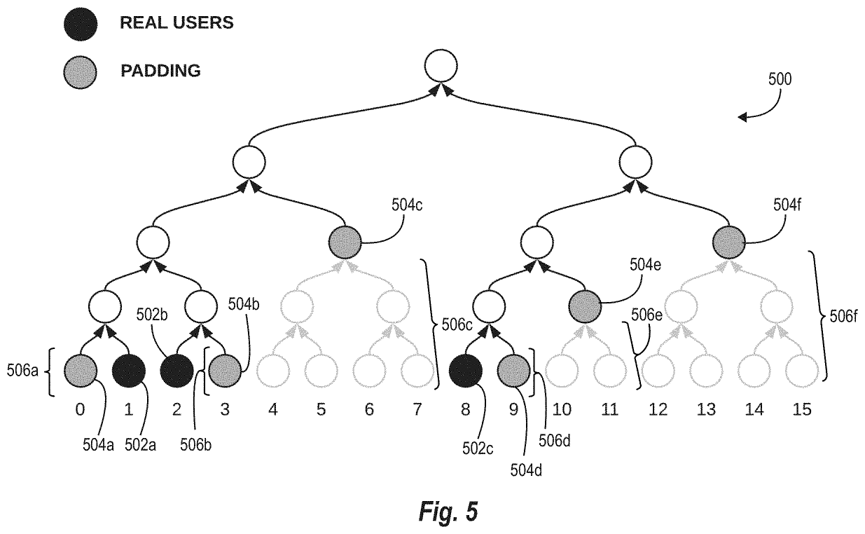

To further illustrate, FIG. 5 shows how the cryptographic proof of liabilities system 102 can utilize padding, in one or more embodiments, only to the roots of empty sub-trees and thus, support tree heights that were not previously possible without extensive and prohibitive computational resources. For example, as shown in FIG. 5, the cryptographic proof of liabilities system 102 generates the deterministic sparse-tree 500 with user leaf nodes 502a, 502b, and 502c. The cryptographic proof of liabilities system 102 obfuscates the number of users by further adding padding nodes 504a, 504b, 504c, 504d, 504e, and 504f. As shown, the cryptographic proof of liabilities system 102 adds the padding nodes 504a-504f only to the roots of empty sub-trees 506a, 506b, 506c, 506d, 506e, and 506f (e.g., a node with no children is considered to be the root of an empty sub-tree, as with the padding nodes 504a, 504b, and 504d).

The tree height reveals the maximum number of users, thus a tree of height=40 can probably support most of today's applications. In practice, the cryptographic proof of liabilities system 102 can pick a big enough tree that will work for next x years even in the most promising forecasting scenarios. Thus, the tree size will likely not need to be updated, which is desirable because updating the tree size would otherwise reveal that something changed (i.e., more users (that surpass previous padding size) entered the system).

As already mentioned, H=40 is a reasonable option in order to obfuscate the total number of users up to 2⁴⁰, but the cryptographic proof of liabilities system 102 can use any height that meets the privacy requirements of the corresponding application.

Accordingly, the cryptographic proof of liabilities system 102 can provide, to each requesting user, an authentication path of 40 nodes. Accordingly, the cryptographic proof of liabilities system 102 selects and utilizes a ZKRP system that is as succinct as possible, thus minimizing verification costs.

Regarding padding size in a sparse tree, given M, the number of users, assuming it is a power of two: M=2^{m}, and H, the height of the tree (the number of leaves in the tree can be at most 2^{H}), the cryptographic proof of liabilities system 102 can estimate the bounds on the number of zero-nodes to add to the tree as follows: (1) in one embodiment all user nodes occupy the left-most leaves of the tree, therefore filling-in the left-most lowest sub-tree of height m, the zero-nodes then need to be added along the path from the root of this sub-tree to the root, there will be at most (H−m) of them added; (2) in another embodiment, all users are evenly dispersed in the leaves of the tree, therefore the lowest sub-trees of height (H−m) will have only one node each and will need (H−m) of zero-nodes to be added to produce the roots of the sub-trees, the number of zero-nodes to be added is then at most (H−m)*2^{m}; and (3) thus, the number of nodes to be added “artificially” is at least (H−m) and at most (H−m)*2^{m}. In at least one embodiment, the cryptographic proof of liabilities system 102 avoids populating the whole tree with zero nodes, to make the tree complete, as the number of zero-nodes would have to be 2^{H-1} which could be impractical or too expensive for a tree with height H≥=32 or otherwise is significantly larger than the number of zero-nodes to be added.

The deterministic sparse-tree should be kept private by the audited entity in order to protect the privacy of its users. The cryptographic proof of liabilities system 102 can publish only the root node, preferably in an immutable public bulletin board (i.e., one or more blockchains) and each individual user should securely and privately receive their own partial proof tree (authentication path). By publishing only one root node, the cryptographic proof of liabilities system 102 can help ensure every user has exactly the same view of the reported proof of liabilities commitment. In one or more embodiments, the cryptographic proof of liabilities system 102 creates a binary tree that is not a full tree and can in theory have any shape.

The cryptographic proof of liabilities system 102 can implement a fixed-height sparse tree solution (e.g., as shown in FIG. 5) to: a) have a consistent and fair authentication path length for every user and b) provide better estimates on population size exposure up to a certain limit, even when users collude between themselves.

In one or more embodiments, the cryptographic proof of liabilities system 102 can utilize a random scattering algorithm to place user leaves in the tree, which is both unique and deterministic. The cryptographic proof of liabilities system 102 can utilize a random scattering algorithm in order to prove that indexes were not manipulated by the prover (i.e., putting those who regularly check their inclusion proofs next to each other with the aim to corrupt parts of the tree that with high probability will not be checked).

In one or more embodiments, the cryptographic proof of liabilities system 102 uses VRFs for computing audit ids, then order users based on their unique and deterministic u_hash value. After ordering, the cryptographic proof of liabilities system 102 can randomly place/scatter them in the tree and then deterministically compute the padding nodes based on the output distribution (again by using VRFs that take as an input the “fake” node index).

Assuming there are S users and the tree supports up to L leaves (thus, its height is log L), if S<<L and the collision probability of the truncated hashes up to log L bits is negligible, then the index per user is defined by u_hash truncated to log L bits. The foregoing is acceptable for CRH hash functions like SHA2 and SHA3 for height=256. However, if there is a significant probability of collisions, i.e., with S=2¹⁶ and L=2³², the probability of collision is roughly 50% and thus a node may not end up with the expected index.

However, the fact that a node is not in the expected index exposes information about the population size; in this particular case, a user whose index has been moved learns that there is at least another user in the tree. The cryptographic proof of liabilities system 102 can utilize a heuristic method to circumvent this problem, which works well when S<<L, by picking the index randomly inside a range close to the expected index. In an alternative embodiment, the cryptographic proof of liabilities system 102 can use a ZKP-based set membership proof to hide any ordering or position evidence.

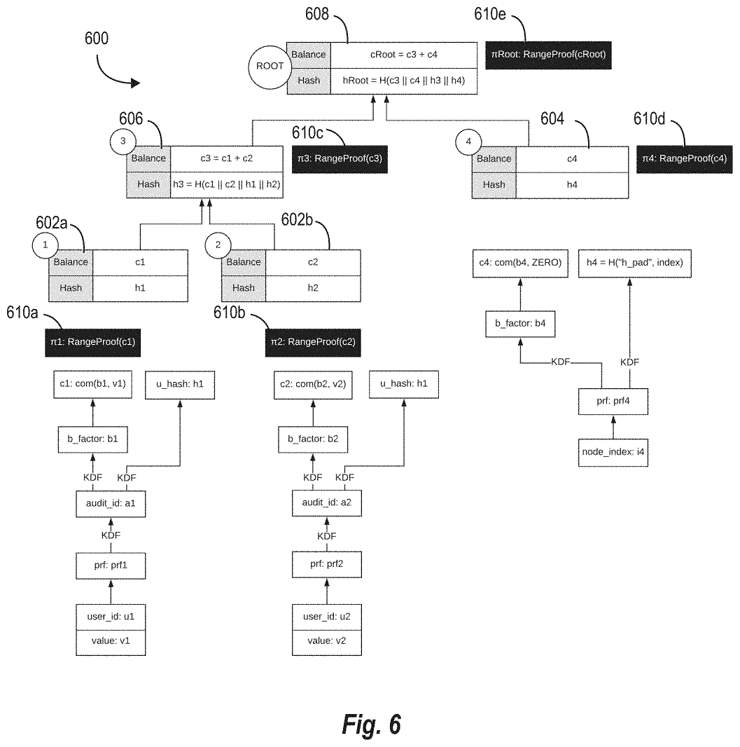

Leaf nodes can represent either user data or padding (fake users with a liability balance of zero) that has been deterministically generated via VRF. For example, FIG. 6 shows a deterministic sparse-tree 600 of height 2, with two user lea nodes 602a, 602b at leaf level and one padding node 604 (to replace the empty leaves) and one internal node 606 at height=1. The deterministic sparse-tree 600 can fit up to four users, but as shown in this example, only one padding node 604 is required due to the sparse tree properties.

The cryptographic proof of liabilities system 102 can deterministically generate the sparse-tree 600 so that it can be regenerated in case of a full audit. Regarding any padding nodes in the sparse-tree 600, the VRF takes as input the index of the padding node to ensure uniqueness. Additionally, the value of any padding node in the sparse-tree 600 is a commitment to zero.

In one or more embodiments, the cryptographic proof of liabilities system 102 configures the leaf nodes 602a, 602b to possess the following values:
user_id: A unique identifier for the user. The user must ensure the uniqueness of this value so using their e-mail or phone number is recommended. Note that the cryptographic proof of liabilities system 102 need not ever reveal this information.
node_index: The node index that is used as the deterministic seed (input) to the KDF/VRF of padding nodes.
prf: The serialized VRF output (if unique and deterministic leaf ordering is required), otherwise one can use a seeded deterministic KDF or HMAC.
audit_id: A unique deterministically generated value per user per audit.
b_factor: A deterministically generated blinding factor used in Pedersen commitments to hide amounts.
u_hash: A hash commitment of user's id.
com: A Pedersen commitment.
π: A range proof on the Pedersen commitment value.
value: A clear (not encrypted) balance.

In at least one embodiment he cryptographic proof of liabilities system 102 can avoid the use of u_hash. However, sometimes a statistical sampling or tree scanning might be required in more demanding audits or for dispute resolution purposes. A distinction between the u_hash and the homomorphic commitment is required to either reveal the balance or the user_id of a leaf node. Thus, the cryptographic proof of liabilities system 102 can ensure that when user's data is revealed, the committed balance is not exposed and vice versa.

In one or more embodiments, the cryptographic proof of liabilities system 102 does not include the range proofs 610a, 610b, 610c, 610d, 610e (π's) as part of the construction of the deterministic sparse-tree 600, but has them accompany the authentication path which is sent to users. Efficient schemes that provide fixed size range proofs (i.e., Gro16 with some trusted setup) or aggregation (i.e., Bulletproofs) can help on producing succinct combined proofs for the full authentication path.

The cryptographic proof of liabilities system 102 can generate the internal node 606 using the function described below. The cryptographic proof of liabilities system 102 can configure an encrypted balance of the internal node 606 to be the result of adding of its children's homomorphic commitments (e.g., the balances of the leaf nodes 602a and 602b). Additionally, the cryptographic proof of liabilities system 102 can configure a hash of the internal node 606 to be the concatenation of all children commitments and hashes (e.g., the commitments and hashes of the leaf nodes 602a, 602b), fed to some hash function, for instance sha256.

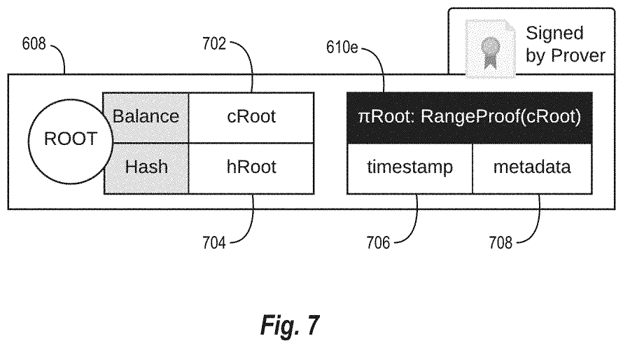

As shown in FIG. 7, he cryptographic proof of liabilities system 102 can configure the root node 608 of the deterministic sparse-tree 600 in the same manner as all internal nodes (e.g., the internal node 606) to possess a balance commitment 702 and a hash 704. In one or more embodiments, the cryptographic proof of liabilities system 102 publishes the data associated with the root node 608 publicly in one or more immutable databases (i.e., blockchains), so that all users can ensure that they are verifying against the same proof tree. As the balance 702 of the root node 608 reflects the total reported liabilities, when published, this data can be accompanied by a range proof 610e of the balance commitment 702, while the full payload, including a timestamp 706 and metadata information 708 related to the audit (i.e., the audit round this proof refers to), can be signed by a prover (indicated by any type of certification).

In one or more embodiments, the cryptographic proof of liabilities system 102 configures an authentication path to contain only the nodes from the complete tree which a given user needs in order to verify he/she was included in the tree. Unlike the original Maxwell scheme where users observe sibling values, each node is accompanied by a range proof on the commitment value to ensure it is a small positive number.

The cryptographic proof of liabilities system 102 can generate an authentication path by starting with the user's leaf node and including every parent node up to the root. To illustrate, in FIG. 6, the cryptographic proof of liabilities system 102 can generate an authentication path associated with the leaf node 602a that includes the leaf node 602a, the internal node 606, and the root node 608. The cryptographic proof of liabilities system 102 can then add the sibling at each level, and thus in practice an authentication path is a list of sibling nodes per height layer. For example, the cryptographic proof of liabilities system 102 can add the leaf node 602b, and the padding node 604 to the authentication path for the leaf node 602a. This can enable the user associated with the leaf node 602a to verify independently that their balance is included in the reported liabilities by following their path to the root node 608, checking at each node in the authentication path that the committed balance is the product of its two children node committed balances.

The cryptographic proof of liabilities system 102 can avoid including nodes that can be directly computed, in one or more embodiments, to save space and encourage users to compute them by themselves. However, in the generic case and when the range of the provided range proofs is very close to the group order used in the commitment scheme, the cryptographic proof of liabilities system 102 can also send the range proofs of the computed nodes as well.

In one or more embodiments, the cryptographic proof of liabilities system 102 generates an authentication path such that a verifier receives the range proofs of sibling nodes only. Despite this, there is at least one edge case embodiment where this is not enough and the cryptographic proof of liabilities system 102 can additionally include the range proofs of the computed nodes in the authentication path.

For example, an exploitable scenario would be to use a range of [0, N] where N is close to the curve order/of the commitment scheme. Then, when merging nodes in the summation tree, although the children nodes are in-range, their product might not be in-range. As a result, the computed product value might overflow. A malicious prover can exploit this by adding a huge fake balance to cancel out everything else in the tree and thus, manage to reduce the total liabilities represented by the root node (e.g., the root node 608).

Current real world financial applications usually dictate a range up to 2⁶4 or 2¹28, which is by far smaller than the typical curve order used in conventional cryptography. But as already mentioned, the cryptographic proof of liabilities system 102 is applicable to a broad range of applications, even outside finance, where ranges may be larger than those acceptable in financial applications.

Therefore, to safely omit the range proofs of computed nodes, the cryptographic proof of liabilities system 102 can configure the allowed range of each commitment to be less than i/H, where/is the group order and H the tree height. Thus, even if every balance is very close to i/H, when the cryptographic proof of liabilities system 102 adds them all together in the authentication path, no intermediate or final value can surpass the group order 1.

There is a drawback, inherent to conventional proof of liability systems, according to which a user who raises a dispute has no cryptographic evidence to support his/her claim. This is because account balances (or negative votes) are just numbers in the prover's accounting book or database and the prover can always claim that the customer never had that balance in his/her account. The problem is very similar to the problem described as, “One day you go to your bank and you realize your account balance is zero, what evidence can you provide to the court?” Along the same lines, “How can a bank prove that it had your consent for all of your transactions?”

To further illustrate, a scenario includes Alice, who wants to make a transaction in a cryptocurrency exchange. Alice connects to the exchange via TLS and authenticates herself using her password. Both Alice and the exchange know for sure withwhom they are communicating. This, however, does not necessarily mean that both Alice and the exchange can fully trust each other. Alice needs a confirmation that the transaction actually happened, and that the exchange cannot act without her permission. On the other hand, the exchange wants evidence that it indeed received a transaction order from Alice.

Unfortunately, Alice cannot easily prove that she has actually sent the transaction order. Likewise, even if Alice can prove the transaction order, the exchange can still claim that the transaction was never processed. Even worse, a malicious employee at the exchange could easily generate and store transactions without Alice's consent.

This scenario is problematic because, typically, transaction orders are just records in conventional databases thus, the main defense is usually data replication and logging. Sadly, none of the above countermeasures can prevent fraud or be used as undeniable proofs. Another side-effect of raw unsigned storage is the feeling that users do not really have control over their funds; assets are just numbers in the exchange's database.

These and other issues are particularly problematic for blockchain exchanges. For example, the primary motivation for users keeping funds with an exchange is to avoid needing to remember long-term cryptographic secrets. As such, exchanges must be able to execute user orders and change their balance without cryptographic authentication from the user (e.g., password authentication). Users who dislike an exchange may also falsely claim that verification of their accounts failed, and it is not possible to judge if there is no transaction proof.

The cryptographic proof of liabilities system 102 provides one potential solution; namely, utilizing signatures or mutual contract signing per transaction. In some applications of the cryptographic proof of liabilities system 102 though (i.e., disapproval voting), receiving a signed ticket/email from the prover only would be sufficient.

As mentioned above, in environments that require continuous and subsequent audits, the cryptographic proof of liabilities system 102 can ensure that the prover is not be able to track who requested or downloaded his/her inclusion proofs. For example, such information could expose data around who is regularly checking the proofs and who rarely or never does. A malicious prover can omit adding balances from users with low probability to check. However, if the prover does not have a clue on who requested and executed the inclusion authentication path, he/she can only speculate and the risk of being caught is a lot higher.

It has already been suggested that ideally, users should use verified and audited third party or locally installed tools to verify the proofs. For example, the cryptographic proof of liabilities system 102 enables users to privately download the leaf index and the audit id (or a related VRF output) associated with their individual leaf node. For instance, as shown by the audit_id 304b shown in FIG. 3, the cryptographic proof of liabilities system 102 can also provide unique audit ids at the time of registration.

In particular, the cryptographic proof of liabilities system 102 can use this audit id via a KDF to be able to derive the commitment's blinding factor. The cryptographic proof of liabilities system 102 can then broadcast or serve the proofs via third party services using PIR (private information retrieval), ORAM (oblivious RAM) and network mixing services. The second approach can allow for lighter clients and the encryption protects the PIR protocol against users who request to download other proof indexes (even if they manage to receive them, they cannot decrypt the commitments). All in all, using deterministic KDF derived audit ids, the cryptographic proof of liabilities system 102 can use regular PIR to simulate an authenticated PIR protocol.

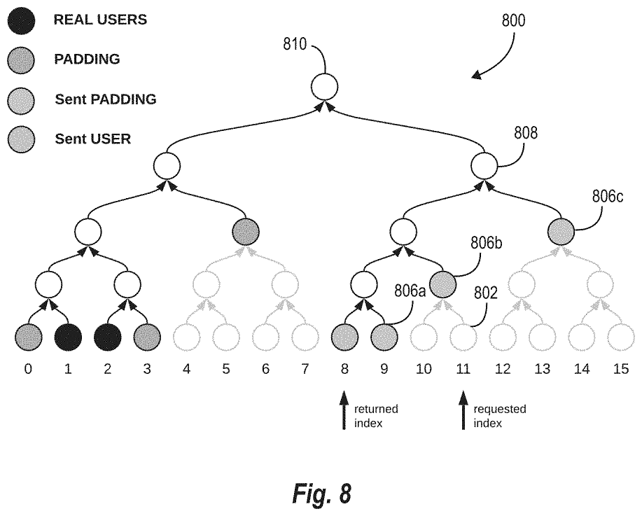

In one or more embodiments, an audit may require full access or random sampling of nodes, especially when investigation takes place due to a dispute. As shown in FIG. 8, the cryptographic proof of liabilities system 102 can generate a deterministic sparse-tree 800 that is compatible with random sampling, as the prover can provide a proof about the closest real user to a requested index. For example, if the auditor requests for the empty leaf node 802 at index=11, the cryptographic proof of liabilities system 102 can reply with the user leaf node 804 and the sibling nodes 806a, 806b, and 806c, along with their shared authentication path including the internal nodes 808a, 808b, and 808c and the root node 810, as a proof that the closest real user at index=11 is the leaf node 804 at index=8. The fact that the padding nodes 806a-806c are constructed with a different input than real user nodes can be used to distinguish between real and artificial users/nodes (e.g., see FIG. 6 for how they differ).

Included here below are proofs of liabilities (PoL) definitions and algorithms that the cryptographic proof of liabilities system 102 utilizes in one or more embodiments.

(TL, aud)←AuditSetup(ACCS). The AuditSetup algorithm takes as input a list of accounts denoted by ACCS and outputs the total liabilities as well as material required for the audit aud. This includes both private and public materials which we denote by aud=(audₚₖ, audₛₖ). For simplicity, the cryptographic proof of liabilities system 102 lets each account in ACCS be a tuple (uid, bal) where uid is a unique user identifier associated with the account and bal is the current balance for the account used in the proof of liabilities.

(Π_{aud})←AuditorProve(aud). The AuditorProve algorithm takes as input the audit material aud output by the AuditSetup and a proof of liability Π_{aud} to be verified by the auditor. The proof intends to show that the claimed total is consistent with the public component of the setup audₚₖ.

{0, 1}←AuditorVerify(TL, audₚₖ, Π_{aud}). The AuditorVerify algorithm takes as input the declared total liabilities TL, the public audit material audₚₖ and the proof Π_{aud}. The AuditorVerify algorithm outputs 1 if the verification passes and 0 otherwise. π_{uid}←UserProve(uid, aud). The UserProve algorithm takes as input the unique user identifier uid for a particular user and the audit material and outputs a user specific proof π_{uid}. {0, 1}←UserVerify(uid, audₚₖ, π_{uid}, bal). The UserVerify algorithm takes as input, the user identifier uid and its balance bal, the public audit material audₚₖ and a proof π_{uid}, and outputs 1 if the proof verifies and 0 otherwise.

For security, the cryptographic proof of liabilities system 102 can bound the probability that a malicious prover can eliminate more than t user balances from the total liabilities using a function δ(c, t), given that the AuditorVerify outputs 1 and UserVerify outputs 1 for a uniformly chosen fraction c of total balances in ACCS. More formally:

$$A proof of liabilities scheme Pol . is δ ( c . t ) - secure for the set of accounts ACCS , if for every 0 < c < 1 and every S ⋐ ACCS of size t , for a randomly chosen set of users U = \{ {u}_{1} , … , {u}_{k} \} ⋐ ACCS where k = c \vert ACCS \vert , \\ Pr [ AuditorVerify ( {aud}_{p k} , {Π}_{aud} ) {⩓}_{i = 1}^{k} UserVerify ( {u}_{i} , {aud}_{p k} , {π}_{{u}_{i}} ) ⩓ {TL}^{′} < liab ( ACCS \backslash S ) \vert ( {TL}^{′} , ( {aud}_{p k} , {aud}_{sk} ) ) ← AuditSetup ; {Π}_{aud} ← AuditorProve ; {π}_{{u}_{i}} ← UserProve ( {u}_{i} , aud ) for {u}_{i} ∈ U ] < δ ( c , t )$$

$$where liab ( A ) denotes the total liabilities of balances in the set A and the probability is over the randomness in choosing U and the coin tosses of the various algorithms .$$

The cryptographic proof of liabilities system 102 can also consider privacy guarantees against dishonest users and a dishonest auditor separately.

An auditor who does not collude with any users only sees the public portion of the audit material audₚₖ, the total liabilities, as well as the proof provided by the prover i.e. Π_{aud}. The cryptographic proof of liabilities system 102 refers to this as the auditor's view in a real execution of the PoL scheme and denote it by ViewAuditor(ACCS). The cryptographic proof of liabilities system 102 can then require that this view can be simulated by a PPT simulator (e.g., a probabilistic polynomial time simulator) that does not see the information in ACCS and only has access to leakage function L(ACCS) which depends on the particular scheme. Examples of such leakage functions are |ACCS| and liab(ACCS). More formally:

A proof of scheme PoL is L-private against a dishonest auditor, if for every PPT auditor [symbol] , there exists a PPT simulator [symbol] such that the following distributions are computationally indistinguishable

[symbol]

( [symbol] CCS)≈ [symbol] (1^{λ},L( [symbol] CCs))

A subset of users U={u₁, . . . , uₙ}, who can collude among each other, get to see the public audit material audₚₖ, those users' balances i.e. tuples of the form

$$B a {l}_{U} = \{ ( {u}_{i} , {bal}_{i} ) \} \frac{n}{i = 1}$$

as well as the set of proofs generated by the prover i.e. {πᵤ₁, . . . , πᵤₙ}. This can be referred to as the adversary's view in the real execution of the PoL scheme and denote it by ViewAU (ACCS) where AU denotes an adversary who controls the users in U. The cryptographic proof of liabilities system 102 then require that this view can be simulated by a PPT simulation that only sees the balances of users in U as well as a leakage function L(ACCS) which depends on the particular scheme. More formally:
A proof of liabilities scheme PoL is L-private against dishonest users if for every subset of users U={u₁, . . . , uₙ}, and every PPT adversary [symbol] _{U} who corrupts the users in U, there exists a PPT simulator [symbol] such that the following distributions are computationally indistinguishable

[symbol]

( [symbol] CCS)≈ [symbol] (1^{λ}, [symbol] CCS[U],L( [symbol] CCS))

where [symbol] CCS[U] is the set of (uid, bal_{uid}) for all uid ∈U.

Centralized Maxwell+Setup:

AuditSetup( [symbol] CCS)

| | |
|---|---|
| 1: | Randomly shuffle the tuples in [symbol] CCS, record the new location of |
| | each tuple after the shuffle as its leaf index and append the index to |
| | the tuple, i.e. update the tuple to (uid, bal_{uid}, index_{uid}). |
| 2: | For every (uid, bal, index) ϵ [symbol] CCS, lot com ← commit(uid; r) |
| | using fresh randomness r, let h ← H(bal_{uid}∥index_{uid}∥com), and |
| | append com, h, r to the tuple to get (uid, bal, index, com, r, h). |
| | Denote the new augmented set of tuples by [symbol] CCS′. |
| 3: | Let d = ┌log₂\| [symbol] CCS′\|┐. Create a full binary tree of depth d where |
| | we store the information for nodes at depth i in an array |
| | Dᵢ[1 . . . 2ⁱ]. Let TL ← 0. |
| 4: | For all 1 ≤ j ≤ 2^{d}, if a tuple (uid, bal, j, com, r, h) is present in |
| | [symbol] CCS′, let D_{d}[j] ← h and TL ← TL + bal. If not, let D_{d}\|j\| ← 0 [symbol] |
| 5: | for i = d − 1 to 1 do |
| 6: | for j = 1 to 2 [symbol] do |
| 7: | Retrieve h_{L} = Dᵢ₊₁[2j − 1] and h_{R} = Dᵢ₊₁[2j] and let Dᵢ[j] ← |
| | H(h_{L}∥h_{H}). |
| 8: | end for |
| 9: | end for |
| 10: | Output aud = (audₚₖ = (TL, D₁), aud [symbol] ₖ = (D₂, . . . D_{d}, [symbol] CCS′)). |

[symbol]

indicates data missing or illegible when filed

Centralized Maxwell+Prove and Verify Algorithms:

AuditorProve(aud)

| | |
|---|---|
| 1: | For every tuple (uid, bal, index, com, r, h) ϵ [symbol] CCS′, append the |
| | tuple (bal, index, com) to II_{aud}. |
| 2: | Output II_{aud} |

AuditorVerify (TL, audₚₖ, II_{aud})

| | |
|---|---|
| 1: | Let total = 0, Dᵢ′ [symbol] , . . . , D_{d}′ [symbol] be empty arrays. For every |
| | tuple (a, index, com) ϵ II_{aud} verify that a > 0. If not output 0 |
| | and abort. Otherwise, let total ← total + a and D_{d}′[index] ← |
| | H(a∥index∥com). |
| 2: | Check if total [symbol] TL and output 0 if it fails. |
| 3: | for i = d − 1 to 1 do |
| 4: | for j = 1 to 2 [symbol] do |
| 5: | Retrieve h_{L} = Dᵢ₊₁′[2j − 1] and h_{R} = Dᵢ₊₁′[2j] and let D [symbol] ′[j] ← |
| | H(h_{L}∥h_{R}). |
| 6: | end for |
| 7: | end for |
| 8: | Check if D₁[1] [symbol] D₁′[1]. If not output 0, else output 1. |

UserProve(uid, aud)

| | |
|---|---|
| 1: | Append the tuple (uid, bal, index, com, r, h) ϵ [symbol] CCS′ associated |
| | with uid to π_{uid}. |
| 2: | Append (d, D_{d}[index]) to π_{uid} |
| 3: | for i = d to 1 do |
| 4: | if (index mod 2) [symbol] 1 then |
| 5: | Append (i, Dᵢ[index + 1]) to π_{uid} |
| 6: | index ← (index + 1)/2 |
| 7: | else |
| 8: | Append (i, Dᵢ[index − 1]) to π_{uid} |
| 9: | index ← index/2 |
| 10: | end if |
| 11: | end for |
| 12: | output π_{uid} |

UserVerify(uid, audₚₖ, π_{uid}, bal)

| | |
|---|---|
| 1: | Retrieve (uid, bal, index, com, r, h) from π_{uid} |
| 2: | verify the commitment given com, uid, r. |
| 3: | Retrieve (d, val) from π_{uid}. Check that val [symbol] H(bal∥index∥com). If |
| | not, output 0. |
| 4: | hash ← val |
| 5: | for i = d to 1 do |
| 6: | Retrieve (i, val) from π_{uid} |
| 7: | if (index mod 2) [symbol] 1 then |
| 8: | hash ← H(hash∥val), index ← (index + 1)/2 |
| 9: | else |
| 10: | hash ← H(val∥hash), index ← index/2 |
| 11: | end if |
| 12: | end for |
| 13: | Check hash [symbol] D₁[1]. If not output 0, else 1. |

[symbol]

indicates data missing or illegible when filed

Distributed Maxwell+Setup:

AuditSetup( [symbol] CCS)

| | |
|---|---|
| 1: | Randomly shuffle the tuples in [symbol] CCS, record the new location of |
| | each tuple after the shuffle as its leaf index and append the index to |
| | the tuple, i.e. update the tuple to (uid, bal_{uid}, index_{uid})- |
| 2: | For every (uid, bal, index) ϵ [symbol] CCS, let com ← commit(uid; r) |
| | using fresh randomness r, let h ← H(bal_{uid}∥index_{uid}∥com), and |
| | append com, h, r to the tuple to get (uid, bal, index, com, r, h). |
| | Denote the new augmented set of tuples by [symbol] CCS′. |
| 3: | Let d = ┌log₂\| [symbol] CCS′\|┐. Create a full binary tree of depth d where |
| | we store the information for nodes at depth i in an array |
| | Dᵢ[1 . . . 2ⁱ]. Let TL ← 0. |
| 4: | For all 1 ≤ j ≤ 2^{d}, if a tuple (uid, bal, j, com, r, h) is present in |
| | [symbol] CCS′, let D_{d}[j] ← (h, bal) and TL ← TL + bal. If not, let |
| | D_{d}[j] ← (0 [symbol] , 0) |
| 5: | for i = d − 1 to 1 do |
| 6: | for j = 1 to 2ⁱ do |
| 7: | Retrieve (h_{L}, bal_{L}) = Dᵢ₊₁[2j − 1] and (h_{R}, bal_{R}) = Dᵢ₊₁[2j] |
| 8: | Let Dᵢ[j] ← (H(bal_{L}∥bal_{R}∥h_{R}∥h_{L}), bal_{L} + bal_{R}). |
| 9: | end for |
| 10: | end for |
| 11: | Output aud = (audₚₖ = (TL, D₁), aud [symbol] ₖ = (D₂, . . . D_{d}, [symbol] CCS′)). |

[symbol]

indicates data missing or illegible when filed

Distributed Maxwell+Prove and Verify Algorithms:

UserProve(uid, aud)

| | |
|---|---|
| 1: | Append the tuple (uid, bal, index, com, r, h) ϵ [symbol] CCS′ associated |
| | with uid to π_{uid}. |
| 2: | for i = d to 1 do |
| 3: | if (index mod 2) [symbol] 1 then |
| 4: | Append (path, i, Dᵢ[index]) and (sib, i, Dᵢ[index + 1]) to π_{uid} |
| 5: | index ← (index + 1)/2 |
| 6: | else |
| 7: | Append (path, i, Dᵢ[index]) and (sib, i, Dᵢ[index − 1]) to π_{uid} |
| 8: | index ← index/2 |
| 9: | end if |
| 10: | end for |
| 11: | output π_{uid} |

UserVerify(uid, audₚₖ, π_{uid}, bal)

| | |
|---|---|
| 1: | Retrieve (uid, bal, index, com, r, h) from π_{uid} |
| 2: | verify the commitment given com, uid, r. |
| 3: | Retrieve (path, d, (hₚ, balₚ)) from π_{uid}. Check that hₚ [symbol] |
| | H(balₚ∥index∥com) and bal [symbol] balₚ. If not, output 0. |
| 4: | for i = d to 2 do |
| 5: | Retrieve (path, i, (hₚ, balₚ)) and (sib, i, (h [symbol] , bal [symbol] )), (path, i − 1, |
| | (h [symbol] bal)) from π_{uid}. |
| 6: | Check that balₚ, bal [symbol] > 0 and bal [symbol] balₚ + bal [symbol] . Output 0 if not. |
| 7: | if (index mod 2) [symbol] 1 then |
| 8: | Check if (h [symbol] H(hₚ∥h [symbol] ) and output 0 if not. |
| 9: | index ← (index + 1)/2 |
| 10: | else |
| 11: | Check if h [symbol] H(h [symbol] ∥hₚ), and output 0 if not. |
| 12: | index ← index/2 |
| 13: | end if |
| 14: | end for |
| 15: | Output 1. |

[symbol]

indicates data missing or illegible when filed

Tree-Provisions Setup:

AuditSetup( [symbol] CCS)

| | |
|---|---|
| 1: | Randomly shuffle the tuples in [symbol] CCS, record the new location of |
| | each tuple after the shuffle as its leaf index and append the index to |
| | the tuple, i.e. update the tuple to (uid, bal_{uid}, index_{uid}). |
| 2: | For every (uid, bal, index) ϵ [symbol] CCS, let R ← H(uid; r) using fresh |
| | randomness r, let Pcom = g^{bal}h^{R}, and h ← H(index∥Pcom), and |
| | append h, Pcom, r to the tuple to get (uid, bal, index, h, Pcom, r, R). |
| | Denote the new augmented set of tuples by [symbol] CCS′. |
| 3: | Let d = ┌log₂\| [symbol] CCS′\|┐. Create a full binary tree of depth d where |
| | we store the information for nodes at depth i in an array |
| | Dᵢ[1 . . . 2 [symbol] ]. Let TL ← 0. |
| 4: | For all 1 ≤ j ≤ 2^{d}, if a tuple (uid, bal, j, h, Pcom, r, R) is present in |
| | [symbol] CCS′, let D_{d}[j] ← (h, Pcom, bal, R) and TL ← TL + bal. If not, let |
| | D_{d}[j] ← (0 [symbol] , Pcom(0, r [symbol] ), 0, r [symbol] ) |
| 5: | for i = d − 1 to 1 do |
| 6: | for j = 1 to 2 [symbol] do |
| 7: | Retrieve (h_{L}, Pcom_{L}, bal_{L}, R_{L}) = Dᵢ₊₁[2j − 1] and (h_{R}, Pcom_{R}, |
| | bal_{R}, R_{R}) = Dᵢ₊₁[2j] |
| 8: | Let Dᵢ[j] ← (H(Pcom_{L}∥Pcom_{R}∥h_{L}∥h_{R}), Pcom_{L} ⊗ Pcom_{R}, bal_{L} + |
| | bal_{R}, R_{L} + R_{R}). |
| 9: | end for |
| 10: | end for |
| 11: | Output aud = (audₚₖ = (TL, D₁), aud [symbol] ₖ = (D₂, . . . D_{d}, [symbol] CCS′)). |

[symbol]

indicates data missing or illegible when filed

Tree-Provisions Prove and Verify Algorithms:

UserProve(uid, aud)

| | |
|---|---|
| 1: | Append the tuple (uid, bal, index, h, Pcom, r, R) ϵ [symbol] CCS′ |
| | associated with uid to π_{uid}. |
| 2: | for i = d to 1 do |
| 3: | if (index mod 2) [symbol] 1 then |
| 4: | Retrieve (h_{L}, Pcom_{L}, bal_{L}, R_{L}) = Dᵢ[index] and (h_{R}, Pcom_{R}, |
| | bal_{R}, R_{R}) = Dᵢ[index + 1] |
| 5: | Compute the range proof [symbol] using bal_{R}, R_{R}. |
| 6: | Append (path, i, h_{L}, Pcom_{L}) and (sib, i, h_{R}, Pcom_{R}, [symbol] ) to |
| | π_{uid} |
| 7: | index ← (index + 1)/2 |
| 8: | else |
| 9: | Retrieve (h_{L}, Pcom_{L}, bal_{L}, R_{L}) = Dᵢ[index − 1] and (h_{R}, Pcom_{R}, |
| | bal_{R}, R_{R}) = Dᵢ[index] |
| 10: | Compute the range proof [symbol] using bal_{L}, R_{L}. |
| 11: | Append (path, i, h_{R}, Pcom_{R}) and (sib, i, h_{L}, Pcom_{L}, [symbol] ) to |
| | π_{uid} |
| 12: | index ← index/2 |
| 13: | end if |
| 14: | end for |
| 15: | output π_{uid} |

UserVerify(uid, audₚₖ, π_{uid}, bal)

| | |
|---|---|
| 1: | Retrieve (uid, bal, index, h, Pcom, r, R) from π_{uid} |
| 2: | verify that R [symbol] H(uid∥r) and R, bal is a valid opening for Pcom |
| 3: | Retrieve (path, d, hₚ, Pcomₚ) from π_{uid}. Check that hₚ [symbol] |
| | H(index∥Pcom). If not, output 0. |
| 4: | for i = d to 2 do |
| 5: | Retrieve (path, i, hₚ, Pcomₚ) and (sib, i, h [symbol] , Pcom [symbol] , [symbol] ), |
| | (path, i − 1, h, Pcom) from π_{uid}. |
| 6: | Verify [symbol] and check that Pcom [symbol] Pcomₚ ⊗ Pcom [symbol] . |
| | Output 0 if not. |
| 7: | if (index mod 2) [symbol] l then |
| 8: | Check if (h [symbol] H(Pcom [symbol] ∥Pcomₚ∥h [symbol] ∥hₚ) and output 0 if |
| | not. |
| 9: | index ← (index + 1)/2 |
| 10: | else |
| 11: | Check if h [symbol] H(Pcom [symbol] ∥Pcomₚ∥h [symbol] ∥hₚ), and output 0 if not. |
| 12: | index ← index/2 |
| 13: | end if |
| 14: | end for |
| 15: | Output 1. |

[symbol]

indicates data missing or illegible when filed

Here is a Us of basic API we need for Pedersen commitments and the accompanying range proofs;

1. ADD(r,s) for scalar r, s

2. Com(m,r)=g^{m}h^{r}

3. Verify(c,m,r)=(c [symbol] m^{m}h^{r})

4. Com(m₁,r₁)⊗Com(m₂,r₂)=Com(m₁+m₂, r₁+r₂)

5. Prove(com(m,r),m,r)→π_{Com*m,r)}⁺. This is the range proof for a fixed range.

6. Verify(Com(m,r),π_{Com(m,r)}⁺) which outputs 1 if and only if range >m>0

Proof. Similar to proof of Theorem 7, the main component of the overall proof, is the following Lemma.
Lemma 10. Let N be the total number of balances, and k be the number of uniformly sampled users who run UserVerify and output 1. The probability that a malicious prover can corrupt balances of t users without getting caught is bounded by

$${( \frac{N - k}{N} )}^{t} .$$

We start by reducing the problem to only considering malicious provers who cheat by setting user balances to zero but perform all other prover steps honestly. In particular, Lemma 11 shows that for any prover that behaves arbitrarily malicious, there exists an alternative strategy that performs all prover steps honestly except for setting a subset of user balances to zero in the leaves (or omitting them from the tree), with the same winning advantage and with equal or lower declared liabilities.
As argued earlier in proof of Theorem 7, for the rest of this discussion we assume that given the binding property of the commitment scheme anti the collision-resistance of the hash function H, we assume that with all but negligible probability, both users and the auditor will receive the same views from she prover.
Lemma 11. For every PPT prover [symbol] , there exists a PPT prover B with equal probability of getting caught and equal or less declared liabilities, who only corrupts user balances by setting them to zero or omitting them from the tree.
Proof. First observe that the two main malicious behaviors performed by the adversary A besides setting balances to zero are to (i) use negative balances or partial sums in computing the summation Merkle tree or (ii) use partial sums for internal nodes that are not the correct sum of its two children. We ignore all other malicious behaviors that do not impact or only increase the total liabilities for the prover as they can only hurt a cheating prover.
Consider a prover A who creates a summation tree with negative balances, negative partial sums, or incorrect partial sums. We call a node corrupted if the value assigned to it is negative or its value is not the sum of values for its two children (only for non-leaf nodes). For any corrupted node a, consider the lowest ancestor (furthest from the root) of a called b that is not corrupted. By definition, at least one of the two children of b are corrupted. This implies that if any of b's descendants are among the k users who perform user verification, they will detect the cheating and report it.
The alternative strategy (taken by B) of replacing the balances of all leaves that descendants of b by a zero balance and making sure that all non-leaf nodes are not corrupted, has the same probability of getting caught. Moreover, note that in the former, total liabilities are at most reduced by l balances where l is the number of leaves below b since value of b is positive by definition. In the former, we explicitly let balances for all leaves under b to be zero and hence obtain equal or higher reduction in total declared liabilities.
Iteratively, repeating this process for all remaining corrupted nodes until none is left, yields our final description of an adversarial prover B who has the same advantage of winning as A and equal or lower total liabilities. [symbol]
Based on Lemma 11, we can focus our attention only on adversaries that set a subset of user balances to zero. In that case, we can invoke the analysis in proof of Theorem 7 to show that the probability for any such adversary to get away with corrupting t balances is bounded by

$${( \frac{N - k}{N} )}^{t} = {( 1 - e )}^{3} .$$

[symbol]

While the cryptographic proof of liabilities system is described herein primarily with reference to proving solvency of cryptocurrency exchanges, other embodiments are possible. For example, the cryptographic proof of liabilities system can prove solvency in connection with other applications, several of which are described below. Regardless of the use case or application, the cryptographic proof of liabilities system provides a proof of total liabilities or obligations or “negative” votes in a way that every user whose value/balance should be included in the aggregated liabilities can transparently verify his/her inclusion in the proof, without learning any information about other users' balances.

Proof of Solvency—The cryptographic proof of liabilities system can generate a proof of solvency. For example, a proof of solvency is a public proof to verify that a custodial service does not run as a fractional reserve, e.g., some of the customer assets could not be withdrawn at any given moment. A proof of solvency involves checking whether liabilities<=reserves. Additionally, a proof of solvency consists of two components: 1) proof of liabilities, and 2) proof of reserves. For example, the cryptographic proof of liabilities system can provide proofs of solvency in connection with any blockchain exchange and/or custodial wallet to transparently prove solvency to a auditors and users alike.

Disapproval Voting—The term negative voting is sometimes used for allowing a voter to reject the entire field of candidates; it can also mean that the only option offered voters is to vote against one or more candidates, but it is sometimes used for systems that allow a voter to choose whether to vote for or against a candidate. For example, in at least one embodiment, a negative (or disapproval) vote is a vote against a candidate, proposal, or service (e.g., negative feedback for hotels or restaurants) and is either counted as minus one or as a weight. Unlike most electoral systems, disapproval voting requires that only negative measures or choices be presented. For instance, disapproval voting schemes generally includes that there is no incentive for the prover to increase the amount of these votes.

The cryptographic proof of liabilities system described herein can prove liability in connection with a disapproval voting scheme, where every candidate receives negative votes and stores them in a local ledger. Such a disapproval voting scheme includes no central authority or web-service to receive votes, and audit and oversee the voting process. For example, the cryptographic proof of liabilities system can generate a proof of liability such that a voter can check his/her inclusion in the reported voting result—thus preventing a malicious entity from attempting to cheat by not including any of the actual votes in a reported voting total.

In some embodiments, the cryptographic proof of liabilities system utilize a homomorphic commitment to ensure that the total reported amount stays hidden, and is only used in comparison with another homomorphic commitment (i.e., to sort candidates without learning their actual voting percentage difference). For example, an election system where competing parties compare homomorphic commitments obscuring voting totals without revealing actual numbers of negative votes (i.e., by using a multi-party computation to produce a range proof of the difference in number of votes).

Dislikes and Offensive Content—A dislike in social platforms can be considered an instance of disapproval voting. For example, each social platform user in a disapproval voting scheme may receive negative votes on a particular post, and be obliged to publish a report on the total number of received dislikes. The cryptographic proof of liabilities system can provide a proof of liability associated with the total number of dislikes such that the user cannot omit some or all of the negative votes from the published report. In this embodiment, the social platform need not run a dislike tracking service because the cryptographic proof of liabilities system described herein is completely decentralized.

The cryptographic proof of liabilities system can apply such a disapproval voting scheme to transparent reports of any type of offensive content, including fake news and hate speech. As with any of the applications described herein, the cryptographic proof of liabilities system can enable any voter to check that their vote has been included in the reported total. In at least one embodiment, the social platform may automatically discard as offensive any post with a total number of disapproval votes that meets a threshold.

Fundraising and ICO—For tax audit purposes, businesses have to report revenue at regular intervals. The cryptographic proof of liabilities system described herein can enable every citizen/buyer associated with a commercial company to automatically contribute to verifying a tax liabilities proof for that commercial company. Utilizing the cryptographic proof of liabilities system, a government or Internal Revenue System need not track individual receipts to crosscheck correctness of the accounting reports.

Syndicated Loans—A syndicated loan is offered by a group of lenders who work together to provide credit to a large borrower. The borrower can be a corporation, an individual project, or a government. Each lender in the syndicate contributes part of the loan amount, and all lenders share in the lending risk. One of the lenders acts as the manager (arranging bank), which administers the loan on behalf of the other lenders in the syndicate.

In one or more embodiments, lenders should not necessarily know the contribution of other lenders due to extra privacy requirements. At the same time, the arranging bank might be liable if it reports fake total contribution. Thus, in this embodiment, the cryptographic proof of liabilities system described herein provides an efficient and accurate cryptographic tool in the cryptographic proof of liabilities system generates a proof of liabilities where user privacy is protected.

Lottery Prizes—Lotteries are tightly controlled, being restricted or at least regulated in most places. Despite this, there have been reports for rigged jackpots and large-scale fraud scandals—making it difficult to demonstrate fairness for genuine lotteries. Some lottery systems utilize blockchain technology and smart contracts, so that players can actually know and trust the probability and revenue distribution. The cryptographic proof of liabilities system described herein can add additional safeties to traditional lottery systems because the prize pool is actually a liability and the organizer does not have any incentive to increase it. For example, the cryptographic proof of liabilities system described herein can transparently hide individual contributions and/or reveal the total prize amount to the winners only.

Credit Score and Financial Obligations—A credit score is a number that represents an assessment of the creditworthiness of a person, or the likelihood that the person will repay his or her debts. Credit scores are traditionally generated based on the statistical analysis of a person's credit report. In addition to its original purpose, credit scores are also used to determine insurance rates and for pre-employment screening.

Usually these services are centralized and credit bureaus maintain a record of a person's borrowing and repaying activities. The cryptographic proof of liabilities system described herein can support the formulation of a new distributed credit system of financial obligations, where users maintain their credit score without requiring a third tracking party. Such a distributed credit system would be less invasive and more private that the traditional credit score system.

Referral Schemes—A referral website is an Internet address or hostname used to refer a visitor to another site. For example, a visitor may click a hyperlink on the referral website, which then leads the user to a referred website. The referral industry is usually monetizing by introducing fees; the referred website should pay back the referrer. However in many cases, (i.e., in gambling websites) the fee is linked with the referred user's activity, for instance registration or depositing funds. Traditionally, the referral website administrator has to blindly trust the report from the referred website to receive the fair payback fee. A similar scenario is referral fees in the real estate business, where fees are charged by one agent or broker to another for a client referral.

The cryptographic proof of liabilities system described herein can provide an extra layer of transparency in the referrals business. For example, the cryptographic proof of liabilities system provides an automatic way for referral generating users to check their personal inclusion proofs, and catch reporting entities that are reporting fake or skewed numbers.

Transparent Reports on Virus Outbreaks—During epidemics and pandemics, affected countries and health organizations report official numbers of infections and fatalities caused by a virus or bacteria. The same is applied at a micro-scale (i.e., cities, hospitals) for various diseases or even occupational accidents per business sector. History has shown that affected countries or organizations might sometimes have an incentive to misrepresent or misreport these numbers, mainly because of the economic impact and social issues that an outbreak and bad news can cause.

One example is the recent 2019-20 coronavirus pandemic (COVID-19), caused by severe acute respiratory syndrome coronavirus 2 (SARS-CoV-2). The outbreak was first identified in Wuhan, Hubei, China, in December 2019, and was recognized as a pandemic by the World Health Organization (WHO) on 11 Mar. 2020. There are reports and rumors implying some governments kept real data figures on the total number of coronavirus case numbers hidden, and under-reported to news outlets on the severity of the outbreak. Along with the negative effects to various world economies, misinformation does not allow drawing conclusive insights from the mortality trajectories, which eventually leads to delays in preparing the health facilities and other health processes to defend against the pandemic. The cryptographic proof of liabilities system described herein offers an extra level of decentralized transparency while simultaneously protecting patient data privacy. For example, each person proven to be infected with the virus can receive a signed response from local authorities or hospital. Then, every day, the cryptographic proof of liabilities system can publish a deterministic sparse-tree such as described herein, where each leaf node corresponds to one person (or a group if multiple members in a family caught the virus). Then, every infected person with a signed response can then check their inclusion in the sparse-tree. Similarly, the cryptographic proof of liabilities system can enable governments to cross-compare their numbers without disclosing the actual amounts.

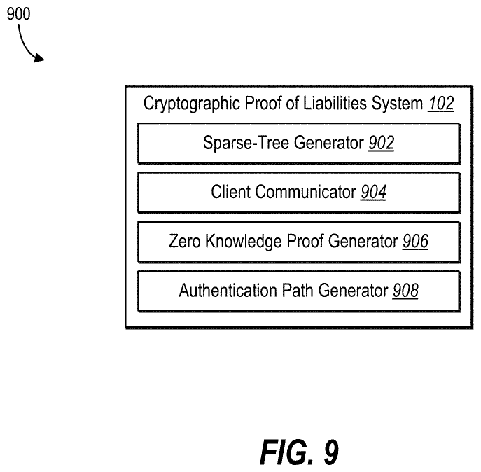

As described in relation in FIGS. 1-8, the cryptographic proof of liabilities system 102 generates deterministic sparse-trees and provides authentication paths verifying that an individual liability in a total liability for the sparse-tree. FIG. 9 illustrates a detailed schematic diagram of an embodiment of the cryptographic proof of liabilities system 102 described above. In one or more embodiments, the cryptographic proof of liabilities system 102 includes a sparse-tree generator 902, a client communicator 904, a zero-knowledge proof generator 906, and an authentication path generator 908.

As discussed above, the augmented reality system 102 can be hosted by a server or can reside on any of the computer nodes 114 or the client devices 112a-112n. In one or more embodiments, the functionality of cryptographic proof of liabilities system 102 may be wholly contained by any of the computer nodes 114 and/or the client devices 112a-112n. Additionally or alternatively, parts of the functionality of the cryptographic proof of liabilities system 102 may be hosted by a server, while other parts of the functionality of the cryptographic proof of liabilities system 102 may be performed by any of the computer nodes 114 and/or the client devices 112a-112n.

As shown in FIG. 9, and as mentioned above, the cryptographic proof of liabilities system 102 can include the sparse-tree generator 902. In one or more embodiments, the sparse-tree generator 902 accesses an immutable database and deterministically generates a sparse-tree including the information in the immutable database. For example, the sparse-tree generator 902 can generate a sparse Merkle tree including a leaf node for each user entry in the immutable database. As discussed above, the sparse-tree generator 902 can generate a deterministic sparse-tree in response to an audit request or an verification proof request.

In one or more embodiments, the sparse-tree generator 902 can deterministically position padding nodes in a sparse-tree. For example, to obscure the number of real users in the sparse-tree and depending on the height of the sparse-tree, the sparse-tree generator 902 can position a plurality of padding nodes in the sparse-tree such that each padding node is positioned at the root of an empty sub-tree.

Additionally, the sparse-tree generator 902 can also generate user leaf nodes for every user represented by the sparse-tree. For example, as discussed above, the sparse-tree generator 902 can determine a committed liability and user identifier associated with a particular user. The sparse-tree generator 902 can further apply a verifiable random function to the committed liability and the user identifier associated with the user to determine a verifiable random function output. The sparse-tree generator 902 can then apply a key derivation function to this output to generate an audit identifier (e.g., the audit_id) and a blinding factor (e.g., b_factor). As discussed above, the sparse-tree generator 902 can derive other deterministically generated values included in each leaf node that are based on the audit identifier and the blinding factor to ensure that the privacy and security of the sparse-tree are maintained.

Additionally, the sparse-tree generator 902 can deterministically split and shuffle leaf nodes. For example, in order to further obscure user numbers and balances, the sparse-tree generator 902 can split the balance associated with a single user across multiple leaf nodes. Furthermore, the sparse-tree generator 902 can shuffle and re-shuffle the leaf nodes in subsequent audits in order to hide users who fail to request verification proofs on a regular basis.

As shown in FIG. 9, and as mentioned above, the cryptographic proof of liabilities system 102 includes the client communicator 904. In one or more embodiments, the client communicator 904 handles communications between the cryptographic proof of liabilities system 102 and auditors and/or individual users. For example, the client communicator 904 can receive audit requests and/or verification requests. The client communicator 904 can further provide to auditors and/or individual users proofs and/or authentication paths in response to the received requests.

As shown in FIG. 9, and as mentioned above, the cryptographic proof of liabilities system 102 includes the zero-knowledge proof generator 906. In one or more embodiments, the zero-knowledge proof generator 906 calculates a proof for every node in the deterministic sparse-tree proving that the balance associated with each node falls within a discrete range, without any knowledge of the actual balance. As discussed above, the zero-knowledge proof generator 906 can provide zero-knowledge proofs for every node in an authentication path to show that the balance of every node is a small, positive number.

As shown in FIG. 9, and as mentioned above, the cryptographic proof of liabilities system 102 includes the authentication path generator 908. In one or more embodiments, in response to receiving a request to verify that a user's committed liability (e.g., number of coins) is included in a total liability for a sparse-tree, the authentication path generator 908 can recursively identify every node from the user's leaf node back to the root node of the sparse-tree. The authentication path generator 908 can provide this list of nodes as the user's authentication path. In at least one embodiment, the authentication path generator 908 can further provide zero-knowledge proofs (e.g., calculated by the zero-knowledge proof generator 906) for every node in the user's authentication path showing the balance reflected by each node is a small, positive number.

Each of the components 902-908 of the cryptographic proof of liabilities system 102 can include software, hardware, or both. For example, the components 902-908 can include one or more instructions stored on a computer-readable storage medium and executable by processors of one or more computing devices, such as a client device or server device. When executed by the one or more processors, the computer-executable instructions of the cryptographic proof of liabilities system 102 can cause the computing device(s) to perform the methods described herein. Alternatively, the components 902-908 can include hardware, such as a special-purpose processing device to perform a certain function or group of functions. Alternatively, the components 902-908 of the cryptographic proof of liabilities system 102 can include a combination of computer-executable instructions and hardware.

Furthermore, the components 902-908 of the cryptographic proof of liabilities system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-908 may be implemented as a stand-alone application, such as a desktop or mobile application. Furthermore, the components 902-908 may be implemented as one or more web-based applications hosted on a remote server. The components 902-908 may also be implemented in a suite of mobile device applications or “apps.”

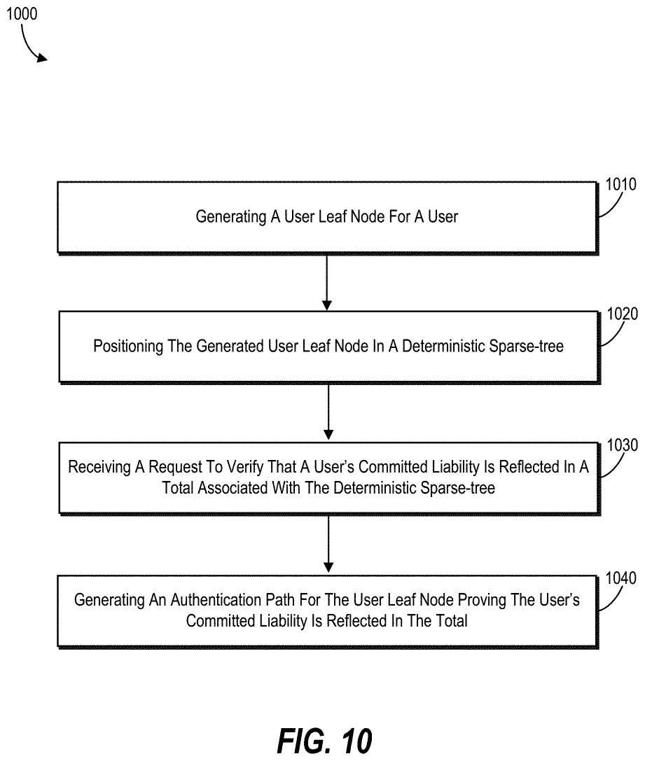

FIGS. 1-9, the corresponding text, and the examples provide a number of different methods, systems, devices, and non-transitory computer-readable media of the cryptographic proof of liabilities system 102. In addition to the foregoing, one or more embodiments can also be described in terms of flowcharts comprising acts for accomplishing a particular result, as shown in FIG. 10. FIG. 10 may be performed with more or fewer acts. Further, the acts may be performed in differing orders. Additionally, the acts described herein may be repeated or performed in parallel with one another or parallel with different instances of the same or similar acts.

As mentioned, FIG. 10 illustrates a flowchart of a series of acts 1000 for generating an authentication path establishing that a user's committed liability is reflected in a total liability for a deterministic sparse-tree in accordance with one or more embodiments. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer-readable medium can comprise instructions that, when executed by one or more processors, cause a computing device to perform the acts of FIG. 10. In some embodiments, a system can perform the acts of FIG. 10.

As shown in FIG. 10, the series of acts 1000 includes an act 1010 of generating a user leaf node for a user. For example, the act 1010 can involve generating a user leaf node for a user by applying a deterministic function to a committed liability and user identifier associated with the user. In one or more embodiments, applying the deterministic function to the committed liability and the user identifier includes applying a verifiable random function to the committed liability and the user identifier associated with the user. In at least one embodiment, applying the deterministic function to the committed liability and the user identifier further includes applying one or more key derivation functions to an output of the verifiable random function to generate an audit identifier and a blinding factor, wherein: the audit identifier is a unique and deterministically generated value; and the blinding factor is a deterministically generated commitment that obfuscates the committed liability. Additionally, the series of acts 1000 can include generating a zero-knowledge range proof associated with the committed liability that proves the committed liability is a small positive number within a predetermined range of numbers.

The series of acts also includes an act 1020 of positioning the generated user leaf node in a deterministic sparse-tree. For example, the act 1020 can involve positioning the generated user leaf node in a deterministic sparse-tree by deterministically shuffling the user leaf node with padding nodes and other user leaf nodes. In one or more embodiments, deterministically shuffling the user leaf node with padding nodes and other user leaf nodes includes: generating user hashes of user identifiers associated with the user leaf node and the other user leaf nodes; ordering the user leaf node and the other user leaf nodes based on the generated user hashes; randomly placing the ordered user leaf node and other user leaf nodes on the deterministic sparse-tree; and deterministically computing the padding nodes based on empty positions in the deterministic sparse-tree. In at least one embodiment, the series of acts 1000 includes an act of positioning the padding nodes in the deterministic sparse-tree as the roots of empty sub-trees of the deterministic sparse-tree. For example, the padding node can include a committed liability of zero.

Furthermore, the series of acts includes an act 1030 of receiving a request to verify that a user's committed liability is reflected in a total associated with the deterministic sparse-tree. For example, the act 1030 can involve receiving a request to verify that the committed liability associated with the user is included in a total liability for the deterministic sparse-tree.

Additionally, the series of acts includes an act 1040 of generating an authentication path for the user leaf node proving the user's committed liability is reflected in the total. For example, the act 1040 can involve generating an authentication path for the user leaf node comprising a list of nodes in the sparse-tree between the user leaf node associated with the user and a root node indicating the total liability, wherein the authentication path establishes that the committed liability associated with the user is reflected in the total liability. In at least one embodiment, the authentication path can further include a zero-knowledge range proof associated with every node in the list of nodes in the sparse-tree between the user leaf node and the root node.

In at least one embodiment, the series of acts 1000 further includes generating an internal node of the deterministic sparse-tree by: identifying a left-child-node of the internal node and a right-child-node of the internal node; generating an encrypted liability for the internal node by adding committed liabilities of the left-child-node and the right-child-node; and generating a hash for the internal node by concatenating all committed liabilities and hashes of the left-child-node and the right-child node. For example, generating the authentication path for the user leaf node can include: identifying, at every level of the sparse-tree starting at the user leaf node and moving up by parent nodes, sibling nodes; and adding, for every level of the sparse-tree, the identified sibling nodes to the authentication path to establish that a committed liability at every level reflects a product of committed liabilities of two children nodes.

In at least one embodiment, the series of acts 1000 includes acts of: publishing the root node of the deterministic sparse-tree to an immutable database; receiving additional requests to verify that committed liabilities associated with other users are included in the total liability for the deterministic sparse-tree; generating additional authentication paths associated with the other users; and comparing the authentication paths to the published root node to ensure every user has the same view of the total liability for the deterministic sparse-tree.

Additionally, in at least one embodiment, the series of acts 1000 includes acts of: receiving an audit request associated with the deterministic sparse-tree; in response to receiving the audit request, re-shuffling the leaf nodes based on hashes of user identifiers in each of the leaf nodes; and re-determining internal nodes for the deterministic sparse-tree such that an encrypted liability for each internal node is a sum of committed liabilities of a left-child-node and a right-child-node of the internal node.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the client devices 112a-112n, and the computer nodes 114). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising
generating a user leaf node for a user by applying a deterministic function to a committed liability and user identifier associated with the user;
positioning the generated user leaf node in a deterministic sparse-tree by deterministically shuffling the user leaf node with padding nodes and other user leaf nodes;
receiving a request to verify that the committed liability associated with the user is included in a total liability for the deterministic sparse-tree; and
generating an authentication path for the user leaf node comprising a list of nodes in the sparse-tree between the user leaf node associated with the user and a root node indicating the total liability, wherein the authentication path establishes that the committed liability associated with the user is reflected in the total liability.

2. The method as recited in claim 1, wherein applying the deterministic function to the committed liability and the user identifier comprises applying a verifiable random function to the committed liability and the user identifier associated with the user.

3. The method as recited in claim 2, wherein applying the deterministic function to the committed liability and the user identifier further comprises applying one or more key derivation functions to an output of the verifiable random function to generate an audit identifier and a blinding factor, wherein:
the audit identifier is a unique and deterministically generated value; and
the blinding factor is a deterministically generated commitment that obfuscates the committed liability.

4. The method as recited in claim 3, wherein deterministically shuffling the user leaf node with padding nodes and other user leaf nodes comprises:
generating user hashes of user identifiers associated with the user leaf node and the other user leaf nodes;
ordering the user leaf node and the other user leaf nodes based on the generated user hashes;
randomly placing the ordered user leaf node and other user leaf nodes on the deterministic sparse-tree; and
deterministically computing the padding nodes based on empty positions in the deterministic sparse-tree.

5. The method as recited in claim 4, further comprising positioning the padding nodes in the deterministic sparse-tree as the roots of empty sub-trees of the deterministic sparse-tree.

6. The method as recited in claim 5, wherein a padding node comprises a committed liability of zero.

7. The method as recited in claim 3, further comprising generating a zero-knowledge range proof associated with the committed liability that proves the committed liability is a small positive number within a predetermined range of numbers.

8. The method as recited in claim 7, wherein the authentication path further comprises a zero-knowledge range proof associated with every node in the list of nodes in the sparse-tree between the user leaf node and the root node.

9. The method as recited in claim 3, further comprising generating an internal node of the deterministic sparse-tree by:
identifying a left-child-node of the internal node and a right-child-node of the internal node;
generating an encrypted liability for the internal node by adding committed liabilities of the left-child-node and the right-child-node; and
generating a hash for the internal node by concatenating all committed liabilities and hashes of the left-child-node and the right-child node.

10. The method as recited in claim 9, wherein generating the authentication path for the user leaf node further comprises:
identifying, at every level of the sparse-tree starting at the user leaf node and moving up by parent nodes, sibling nodes; and
adding, for every level of the sparse-tree, the identified sibling nodes to the authentication path to establish that a committed liability at every level reflects a product of committed liabilities of two children nodes.

11. The method as recited in claim 1, further comprising:
publishing the root node of the deterministic sparse-tree to an immutable database;
receiving additional requests to verify that committed liabilities associated with other users are included in the total liability for the deterministic sparse-tree;
generating additional authentication paths associated with the other users; and
comparing the authentication paths to the published root node to ensure every user has the same view of the total liability for the deterministic sparse-tree.

12. The method as recited in claim 1, further comprising:
receiving an audit request associated with the deterministic sparse-tree;
in response to receiving the audit request, re-shuffling the leaf nodes based on hashes of user identifiers in each of the leaf nodes; and
re-determining internal nodes for the deterministic sparse-tree such that an encrypted liability for each internal node is a sum of committed liabilities of a left-child-node and a right-child-node of the internal node.

13. A system comprising:
at least one processor; and
at least one non-transitory computer-readable storage medium storing instructions thereon that, when executed by the at least one processor, cause the system to:
generate a user leaf node for a user by applying a deterministic function to a committed liability and user identifier associated with the user;
position the generated user leaf node in a deterministic sparse-tree by deterministically shuffling the user leaf node with padding nodes and other user leaf nodes;
receive a request to verify that the committed liability associated with the user is included in a total liability for the deterministic sparse-tree; and
generate an authentication path for the user leaf node comprising a list of nodes in the sparse-tree between the user leaf node associated with the user and a root node indicating the total liability, wherein the authentication path establishes that the committed liability associated with the user is reflected in the total liability.

14. The system as recited in claim 13, wherein applying the deterministic function to the committed liability and the user identifier comprises:
applying a verifiable random function to the committed liability and the user identifier associated with the user; and
applying one or more key derivation functions to an output of the verifiable random function to generate an audit identifier and a blinding factor, wherein:
the audit identifier is a unique and deterministically generated value; and
the blinding factor is a deterministically generated commitment that obfuscates the committed liability.

15. The system as recited in claim 14, wherein deterministically shuffling the user leaf node with padding nodes and other user leaf nodes comprises:
generating user hashes of user identifiers associated with the user leaf node and the other user leaf nodes;
ordering the user leaf node and the other user leaf nodes based on the generated user hashes;
randomly placing the ordered user leaf node and other user leaf nodes on the deterministic sparse-tree; and
deterministically computing the padding nodes based on empty positions in the deterministic sparse-tree by positioning the padding nodes in the deterministic sparse-tree as the roots of empty sub-trees of the deterministic sparse-tree.

16. The system as recited in claim 15, further storing instructions thereon that, when executed by the at least one processor, cause the system to generate a zero-knowledge range proof associated with the committed liability that proves the committed liability is a small positive number within a predetermined range of numbers, wherein the authentication path further comprises a zero-knowledge range proof associated with every node in the list of nodes in the sparse-tree between the user leaf node and the root node.

17. The system as recited in claim 16, further storing instructions thereon that, when executed by the at least one processor, cause the system to further storing instructions thereon that, when executed by the at least one processor, cause the system to generate an internal node of the deterministic sparse-tree by:
identifying a left-child-node of the internal node and a right-child-node of the internal node;
generating an encrypted liability for the internal node by adding committed liabilities of the left-child-node and the right-child-node; and
generating a hash for the internal node by concatenating all committed liabilities and hashes of the left-child-node and the right-child node.

18. The system as recited in claim 17, further storing instructions thereon that, when executed by the at least one processor, cause the system to further storing instructions thereon that, when executed by the at least one processor, cause the system to generate the authentication path for the user leaf node by:
identifying, at every level of the sparse-tree starting at the user leaf node and moving up by parent nodes, sibling nodes; and
adding, for every level of the sparse-tree, the identified sibling nodes to the authentication path to establish that a committed liability at every level reflects a product of committed liabilities of two children nodes.

19. A non-transitory computer-readable medium storing instructions thereon that, when executed by at least one processor, cause a computing device to:
generate a user leaf node for a user by applying a deterministic function to a committed liability and user identifier associated with the user;
position the generated user leaf node in a deterministic sparse-tree by deterministically shuffling the user leaf node with padding nodes and other user leaf nodes;
receive a request to verify that the committed liability associated with the user is included in a total liability for the deterministic sparse-tree; and
generate an authentication path for the user leaf node comprising a list of nodes in the sparse-tree between the user leaf node associated with the user and a root node indicating the total liability, wherein the authentication path establishes that the committed liability associated with the user is reflected in the total liability.

20. The non-transitory computer-readable medium as recited in claim 19, wherein applying the deterministic function to the committed liability and the user identifier comprises:
applying a verifiable random function to the committed liability and the user identifier associated with the user; and
applying one or more key derivation functions to an output of the verifiable random function to generate an audit identifier and a blinding factor, wherein:
the audit identifier is a unique and deterministically generated value; and
the blinding factor is a deterministically generated commitment that obfuscates the committed liability.
